(19) United States
(12) Patent Application Publication
(10) Pub. No.: US 2025/0164853 A1
(43) Pub. Date: May 22, 2025

(54) LENS DRIVING DEVICE, CAMERA DEVICE, AND OPTICAL INSTRUMENT

(71) Applicant: LG INNOTEK CO., LTD., Seoul (KR)

(72) Inventors: Hyung Joo LEE, Seoul (KR); Tae Bong PARK, Seoul (KR); Dong Hyeon SEOL, Seoul (KR)

(21) Appl. No.: 18/841,750

(22) PCT Filed: Jan. 17, 2023
(86) PCT No.: PCT/KR2023/000789

§ 371 Date: Aug. 27, 2024

(30) Foreign Application Priority Data
Mar. 17, 2022 (KR) 10-2022-0033654

(51) Int. Cl. G03B 5/00; G02B 7/09; G02B 27/64; G03B 3/10; G03B 13/36

(52) U.S. Cl. CPC G03B 5/00; G02B 7/09; G02B 27/646; G03B 3/10; G03B 13/36; G03B 2205/0069

(57) ABSTRACT

The present embodiment relates to a lens driving device comprising: a base; a first holder disposed on the base; a second holder disposed inside the first holder; a first coil and a first magnet which move the second holder in an optical axis direction; a second coil and a second magnet which move the first holder in an x-direction or a y-direction perpendicular to an optical axis; and a first ball disposed between the top plate of the base and the top plate of the first holder, wherein the first ball guides the first holder to move relative to the base in the x-direction and the y-direction perpendicular to the optical axis.

### TECHNICAL FIELD

The present embodiment relates to a lens driving device, a camera device and an optical instrument.

### BACKGROUND ART

A camera device is a device that photographs a picture or video of a subject, and is installed in optical devices such as smartphones, drones, and vehicles.

In camera devices, an auto focus (AF) function that automatically adjusts the focus according to the distance between the camera device and the subject is required. In addition, in order to improve image quality, camera devices are required to have optical image stabilization (OIS) function that corrects image shaking caused by the user's movement.

However, as the diameter of the lens has recently increased as image sensors have become higher resolution, the driving force required for moving the lens to perform the autofocus function or optical image stabilization function is increasing.

(Patent Literature 1) KR 10-0849580 B1

### DETAILED DESCRIPTION OF THE INVENTION

### Technical Subject

The present embodiment is intended to provide a lens driving device that provides increased driving force within a limited size.

### Technical Solution

A lens driving device according to the present embodiment comprises: a base; a first holder being disposed on the base; a second holder being disposed inside the first holder; a first coil and a first magnet which move the second holder in an optical axis direction; a second coil and a second magnet which move the first holder in an x-direction or a y-direction perpendicular to an optical axis; and a first ball being disposed between the upper plate of the base and the upper plate of the first holder, wherein the first ball may guide the first holder to move in the x-direction and the y-direction perpendicular to the optical axis with respect to the base.

The upper plate of the base comprises a first groove in which the first ball is disposed, and the first groove may have a size larger than the maximum diameter of the first ball.

When the center of the first ball and the center of the first groove are disposed to coincide with each other, a side surface of the first ball may be spaced apart from an inner side surface of the first groove in the x-direction and the y-direction.

The first ball has first to fourth unit balls, and the first unit ball can guide the first holder to move in the x-direction and the y-direction perpendicular to the optical axis with respect to the base.

It comprises a second ball being disposed between the first holder and the second holder, and the second ball can guide the second holder to move in an optical axis direction with respect to the first holder.

The inner side surface of the first holder comprises a second groove that guides the second ball, and an outer side surface of the second holder may comprise a third groove disposed at a position corresponding to the second groove of the first holder.

The inner corner area of the first holder comprises two surfaces that meet each other, and the second groove may be formed on one of the two surfaces.

An inner shape of the first holder may correspond to an outer shape of the second holder.

The lens driving device may comprise a wire supporting the first holder with respect to the base.

The lens driving device may comprise: a first substrate disposed on the base; an elastic member disposed on the first holder; and a wire connecting the first substrate and the elastic member.

The lens driving device comprises a second substrate disposed on the first holder, and the second coil may be disposed on the second substrate.

The second magnet may be disposed on the base.

The second substrate may be disposed between the second coil and the second magnet to be overlapped with the second coil and the second magnet.

The lens driving device may comprise a third substrate disposed on the first holder, and the first coil may be disposed on the third substrate.

The first magnet may be disposed on the second holder.

A lens driving device according to the present embodiment comprises: a base; a first holder disposed on the base; a second holder disposed inside the first holder; a first magnet disposed in the second holder; a second magnet disposed in the base; a first coil and a second coil coupled to the first holder; a first ball disposed between the base and the first holder; and a second ball disposed between the first holder and the second holder, wherein the first ball is disposed between a upper plate of the base and a upper plate of the first holder, and wherein the second ball may be disposed between an inner side surface of the first holder and an outer side surface of the second holder.

A lens driving device according to the present embodiment comprises: a fixed part; a first moving part moving in an x-direction or a y-direction with respect to the fixed part; a second moving part moving in a z-direction with respect to the first moving part; a first ball disposed between the fixed part and the first moving part; a second ball disposed between the first moving part and the second moving part; and a wire coupled to the fixed part and the first moving part, wherein the first ball guides the first moving part to move in the x-direction and the y-direction and may be disposed outside an area of the first moving part connected to the wire.

Two of the wires may be coupled to at least one corner of the first moving part.

A camera device according to the present embodiment may comprises: a printed circuit board; an image sensor disposed on the printed circuit board; the lens driving device disposed on the printed circuit board; and a lens coupled to the second holder of the lens driving device.

An optical instrument according to the present embodiment may comprise: a main body; the camera device disposed on the main body; and a display disposed on the main body and outputting images photographed by the camera device.

### Advantageous Effects

Through the present embodiment, compared to a structure in which a ball for guiding driving in an x-axis direction and a ball for guiding driving in a y-axis direction are used separately, the driving force can be increased by about 1.5 times when a camera device is at the same height.

In addition, the performance of the autofocus function and optical image stabilization function can be maintained regardless of the direction the camera device is facing. In other words, the aspect of maintaining performance depending on the difference in posture of a camera device can be improved.

In addition, crosstalk between the driving force in an x-axis direction and the driving force in a y-axis direction, which may occur as a result of using a ball that guides both an x-axis direction and a y-axis direction, can be resolved by a wire. In more detail, the phenomenon of moving in a y-axis direction due to the driving force in an x-axis direction or moving in an x-axis direction due to the driving force in a y-axis can be prevented.

In addition, by applying insert injection molding to the ball rolling surface of the base and OIS holder, ball dent phenomenon that occurs after impact, such as in impact reliability tests, can be minimized. In other words, changes in the shape of the ball, such as distortion of the ball, can be minimized. Conversely, the phenomenon of one or more of the base and the OIS holder being dented or recessed by the ball can be minimized.

### BRIEF DESCRIPTION OF DRAWINGS

FIG. 1 is a perspective view of a lens driving device according to the present embodiment.

FIG. 2 is a cross-sectional view taken along line A-A of FIG. 1.

FIG. 3 is a cross-sectional view taken along line B-B of FIG. 1.

FIG. 4 is a cross-sectional view taken along line C-C of FIG. 1.

FIG. 5 is a cross-sectional view and a partially enlarged view illustrating a lens driving device according to the present embodiment cut in a direction perpendicular to the optical axis.

FIG. 6 is an exploded perspective view of a lens driving device according to the present embodiment.

FIG. 7 is an exploded perspective view of a lens driving device according to the present embodiment viewed from a different direction than FIG. 6.

FIG. 8 is a perspective view of a lens driving device according to the present embodiment with a cover member omitted.

FIG. 9 is a side see-through view illustrating a partial configuration of a lens driving device in the state of FIG. 8.

FIG. 10 is a side see-through view illustrating an additional configuration by seeing through compared to FIG. 9.

FIG. 11 is a cross-sectional view illustrating a cross-section in which an OIS guide ball is cut in a lens driving device according to the present embodiment.

FIG. 12 is a perspective view of a lens driving device according to the present embodiment with a cover member and base omitted.

FIG. 13 is a side see-through view illustrating a partial configuration of a lens driving device in the state of FIG. 12 by seeing through.

FIG. 14 is a side see-through view illustrating an additional configuration compared to

FIG. 13 by seeing through.

FIG. 15 is a cross-sectional view illustrating a cross-section, in which an OIS guide ball is cut, in a lens driving device according to the present embodiment.

FIG. 16 is a cross-sectional perspective view and partially enlarged view of a portion of a lens driving device according to the present embodiment.

FIG. 17 is a cross-sectional perspective view illustrating a state in which the AF holder of a lens driving device according to the present embodiment moves upward and comes into contact with a upper plate of a cover member.

FIG. 18 is a perspective view of a lens driving device according to the present embodiment with a cover member and an OIS holder omitted.

FIG. 19 is a cross-sectional perspective view illustrating a cross-section cut in a way that some components are omitted in a lens driving device according to the present embodiment so that an OIS guide ball can be cut.

FIG. 20 is a side view with some components omitted to show the arrangement of an AF guide ball and an OIS guide ball in a lens driving device according to the present embodiment.

FIG. 21 is a perspective view of a lens driving device in the state of FIG. 20.

FIGS. 22a and 22b are perspective views of some configurations of a lens driving device according to the present embodiment.

FIG. 23 is a perspective view illustrating a coupled state of an elastic member, a wire, and a substrate of a lens driving device according to the present embodiment.

FIG. 24 is a perspective view illustrating a partial configuration of a lens driving device according to the present embodiment.

FIG. 25 is a perspective view illustrating an AF moving part and related configuration of a lens driving device according to the present embodiment.

FIG. 26 is a bottom view and partially enlarged view of a lens driving device according to the present embodiment.

FIGS. 27 and 28 are diagrams for explaining AF driving of a lens driving device according to the present embodiment.

FIGS. 29 to 31 are diagrams for explaining OIS driving of a lens driving device according to the present embodiment.

FIG. 32 is an exploded perspective view of a camera device according to the present embodiment.

FIG. 33 is a perspective view of an optical instrument according to the present embodiment.

FIG. 34 is a perspective view of an optical device according to the present embodiment seen from a direction different from that of FIG. 33.

FIG. 35 is a perspective view of an optical device according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or arranged in “on (above)” or “below (under)” of each component, “on (above)” or “below (under)” means that it comprises not only the case where the two components are directly in contact with, but also the case where one or more other components are formed or arranged between the two components. In addition, when expressed as “on (above)” or “below (under)”, the meaning of not only an upward direction but also a downward direction with respect to one component may be comprised.

The ‘optical axis direction’ used hereinafter is defined as the optical axis direction of the lens and/or image sensor being coupled to the lens driving device.

The ‘vertical direction’ used hereinafter may be a direction parallel to an optical axis direction. The vertical direction may correspond to a ‘z-axis direction’. The ‘horizontal direction’ used hereinafter may be a direction perpendicular to the vertical direction. That is, the horizontal direction may be a direction perpendicular to the optical axis. Therefore, the horizontal direction may comprise an ‘x-axis direction’ and a ‘y-axis direction’.

The ‘auto focus (AF) function’ used hereinafter is defined as a function that automatically focuses on the subject by adjusting the distance from the image sensor by moving the lens in an optical axis direction according to the distance so as to obtain a clear image of the subject on the image sensor. In addition, ‘closed-loop auto focus (CLAF) control’ is defined as real-time feedback control of the position of the lens by detecting the distance between the image sensor and the lens so as to enhance the accuracy in focus control.

The ‘optical image stabilization (OIS) function’ used hereinafter is defined as a function that moves or tilts the lens in a direction perpendicular to an optical axis so as to offset vibration (movement) generated in the image sensor by external force.

Hereinafter, any one of an ‘AF holder’ and an ‘OIS holder’ may be referred to as a ‘first holder’ and the other may be referred to as a ‘second holder’. In addition, any one among an ‘AF substrate’, ‘OIS substrate’, and ‘FPCB’ is referred to as a ‘first substrate’, the other one is referred to as a ‘second board’, and the remaining one can be referred to as a ‘third board’. In addition, any one of an ‘AF coil’ and an ‘OIS coil’ may be referred to as a ‘first coil’ and the other may be referred to as a ‘second coil’. In addition, any one of an ‘AF magnet’ and an ‘OIS magnet’ can be referred to as a ‘first magnet’ and the other can be referred to as a ‘second magnet’. In addition, any one of an ‘AF guide ball’ and an ‘OIS guide ball’ is referred to as a ‘first ball’, and the other one can be referred to as a ‘second ball’. In addition, any one of an ‘OIS-x coil’ and an ‘OIS-y coil’ is referred to as a ‘first unit coil’ and the other may be referred to as a ‘second unit coil’. In addition, any one of an ‘OIS-x magnet’ and an ‘OIS-y magnet’ is referred to as a ‘first unit magnet’ and the other one may be referred to as a ‘second unit magnet’. In addition, any one among an ‘AF coil’, an ‘OIS-x coil’, and an ‘OIS-y coil’ is referred to as a ‘first coil’, the other one is referred to as a ‘second coil’, and the remaining one may be referred to as a ‘third coil’. In addition, any one among an ‘AF magnet’, an ‘OIS-x magnet’, and an ‘OIS-y magnet’ is referred to as a ‘first magnet’, the other one is referred to as a ‘second magnet’, and the remaining one may be referred to as a ‘third magnet’.

Hereinafter, the configuration of the lens driving device according to the present embodiment will be described with reference to the drawings.

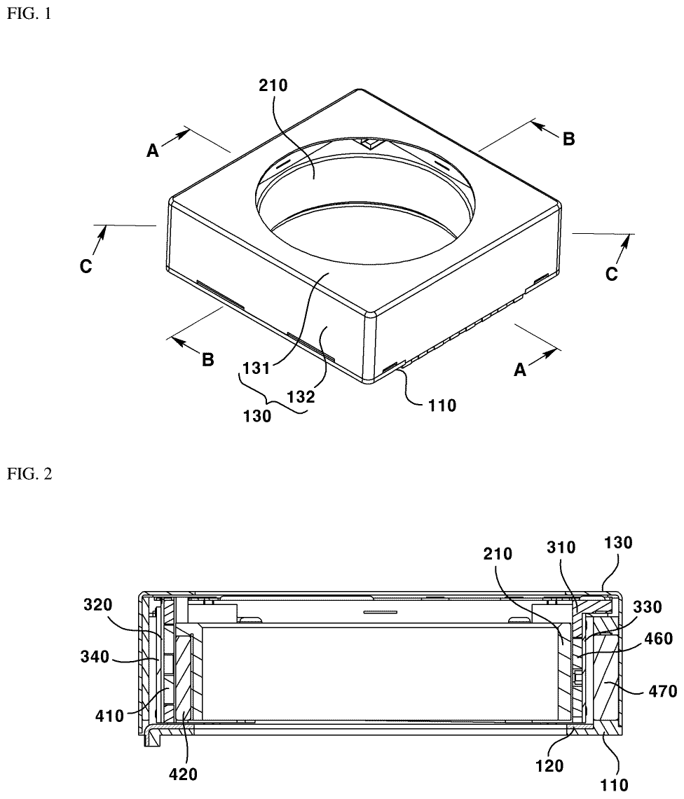

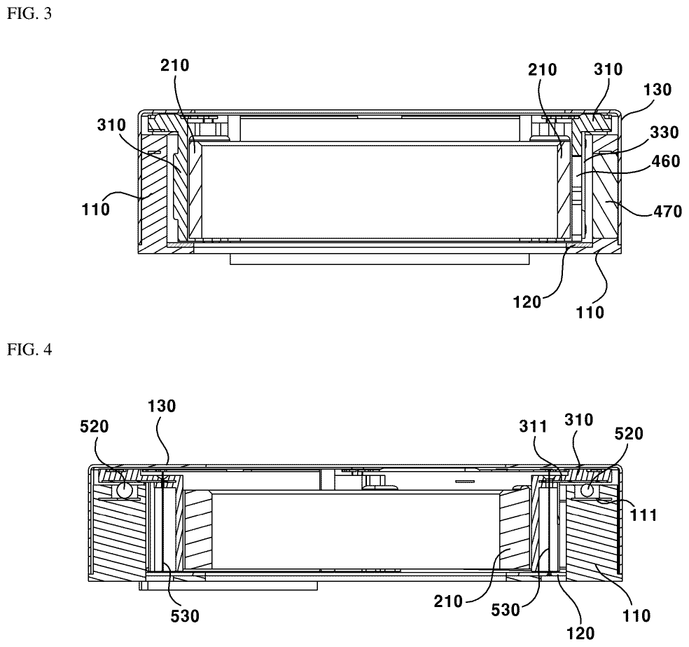

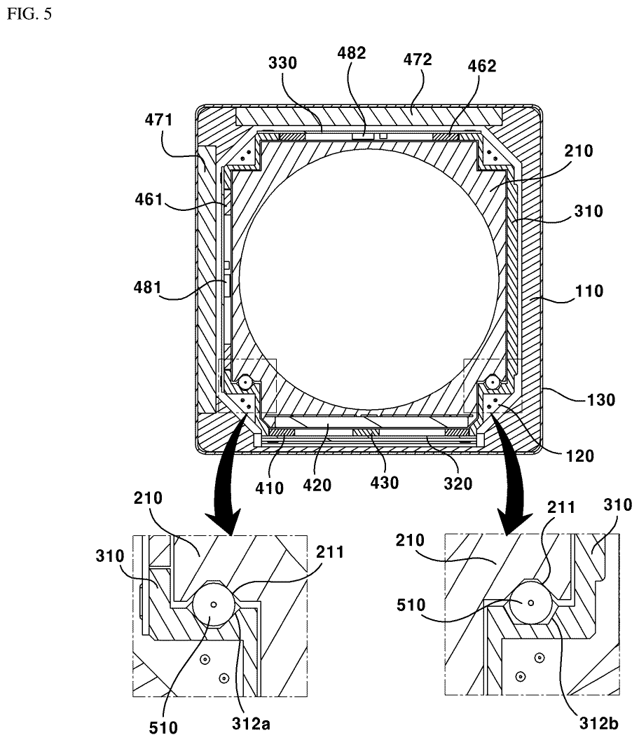

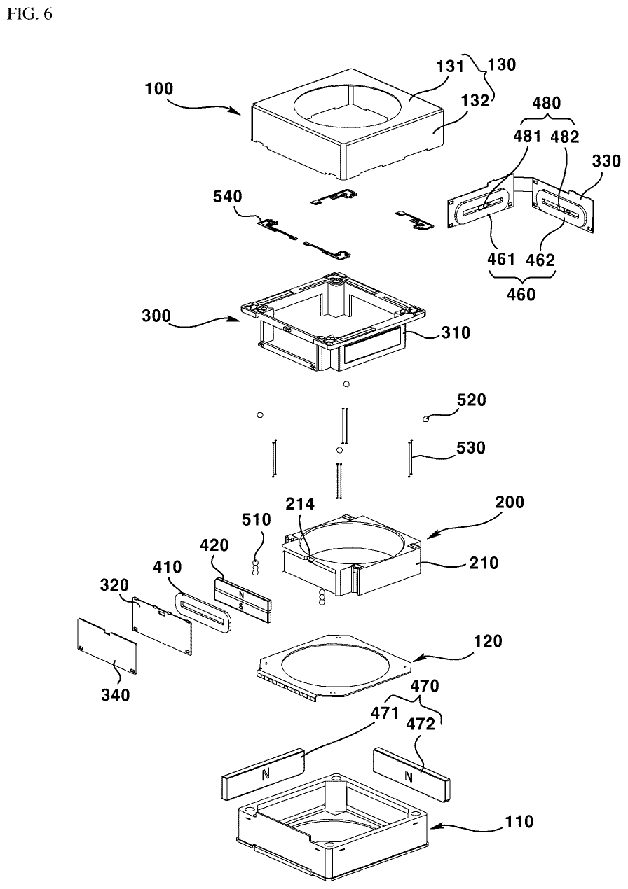

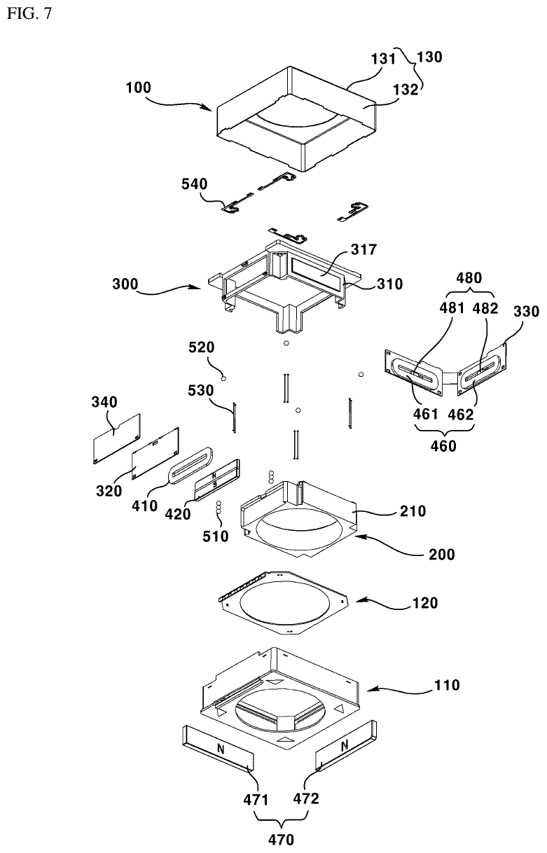

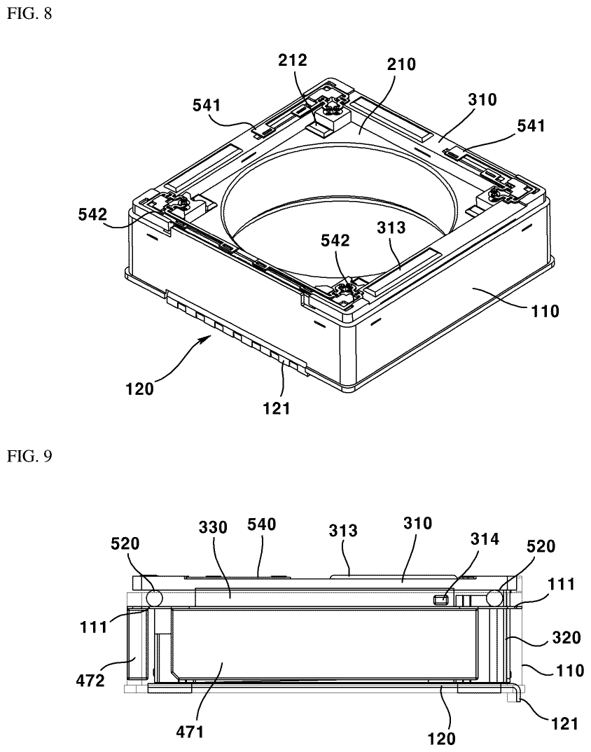

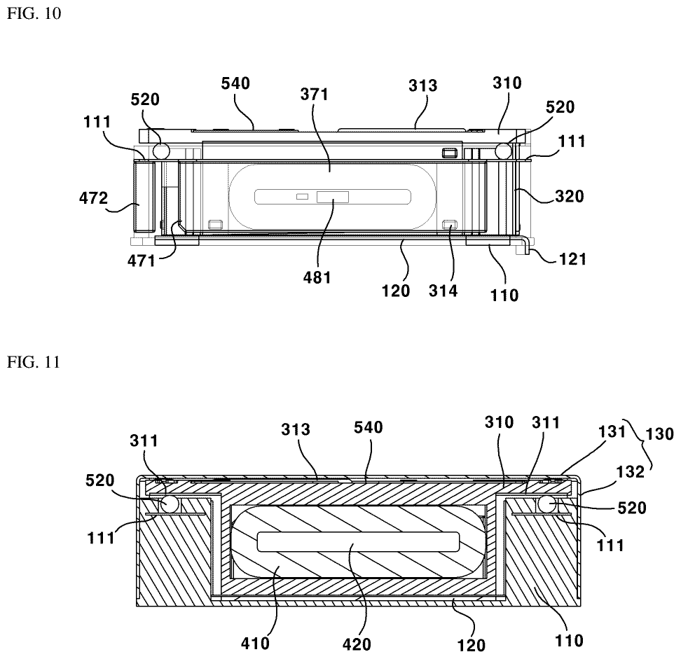

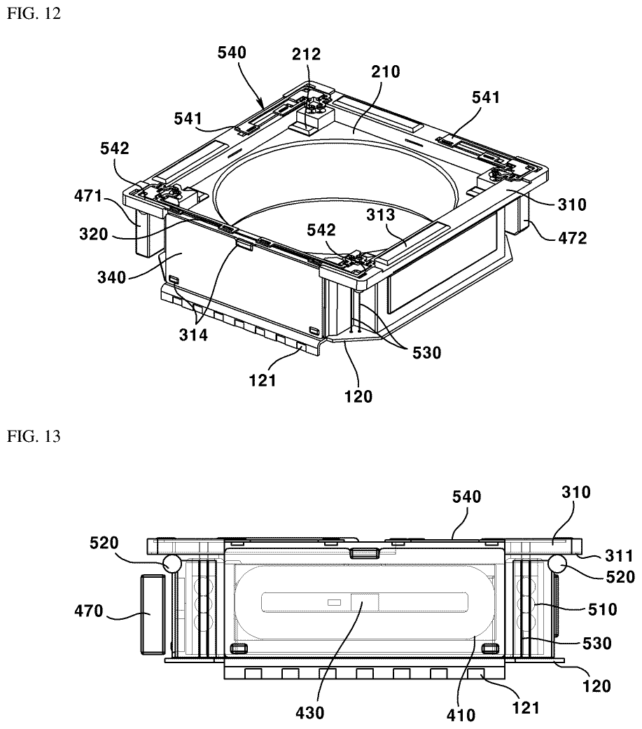

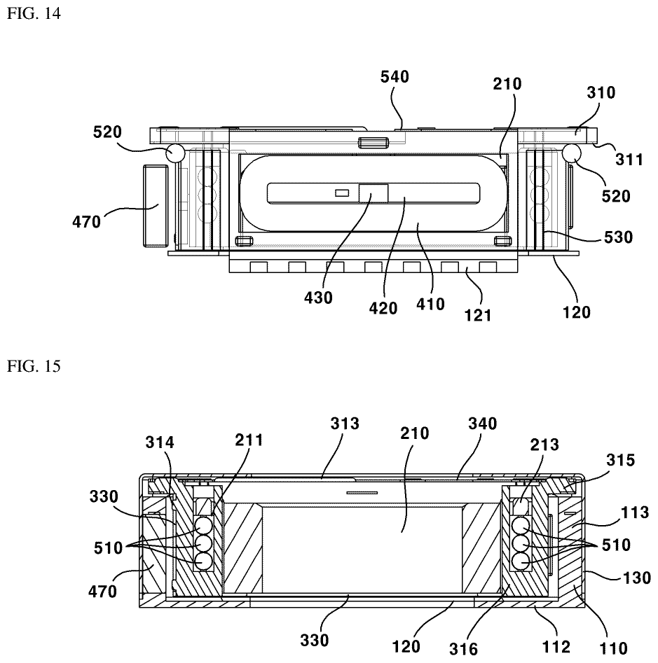

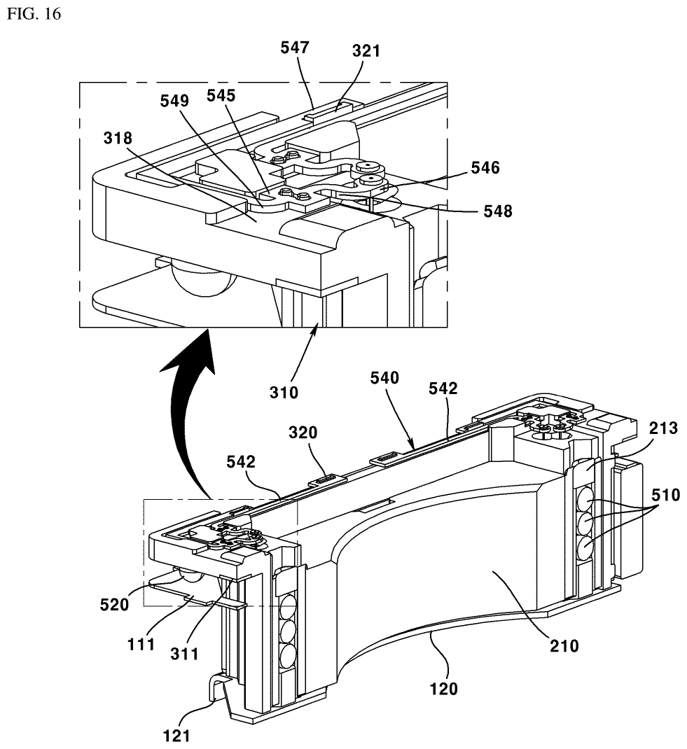

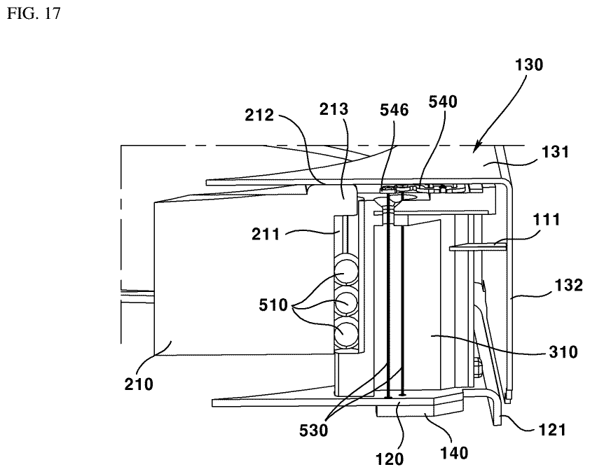

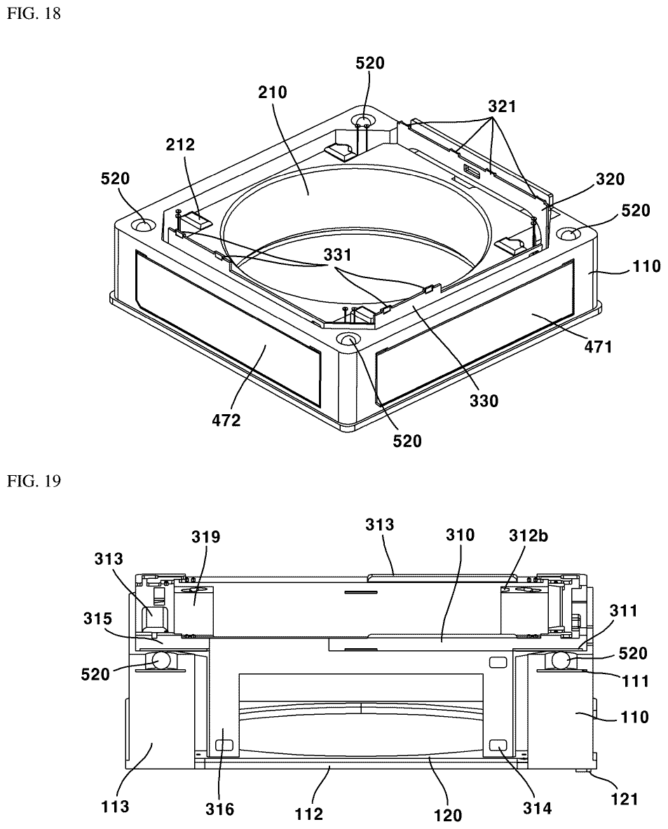

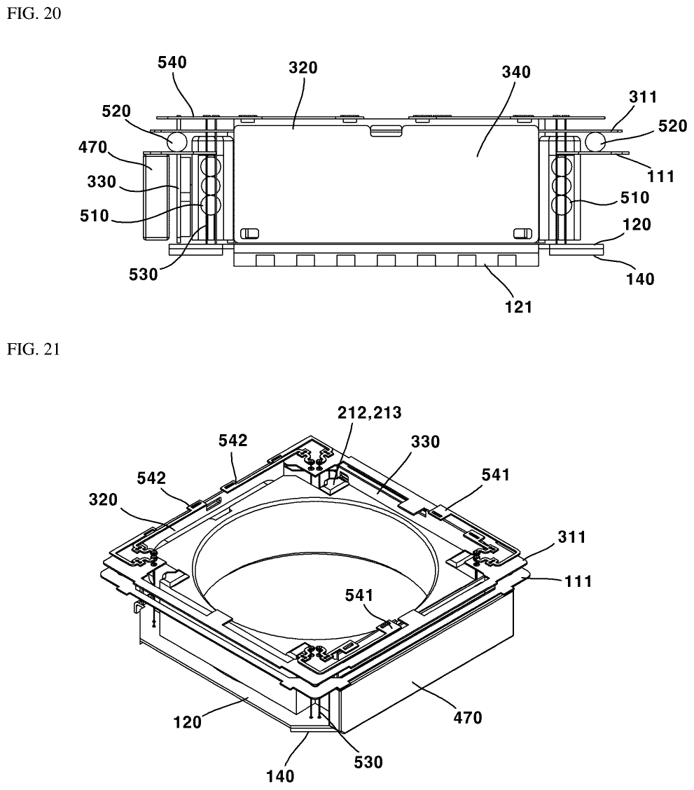

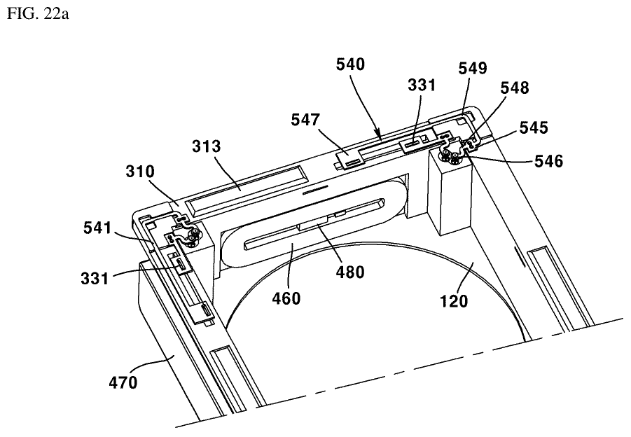

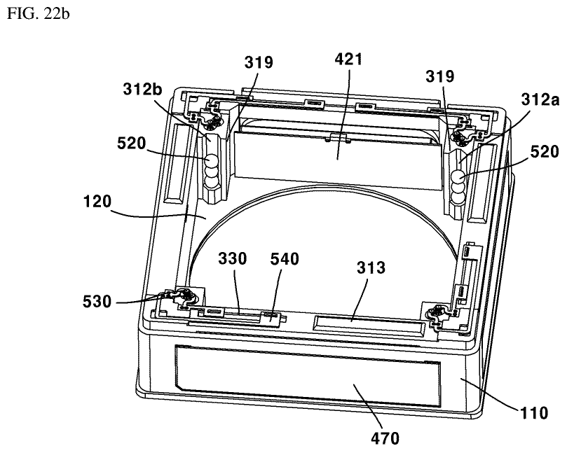

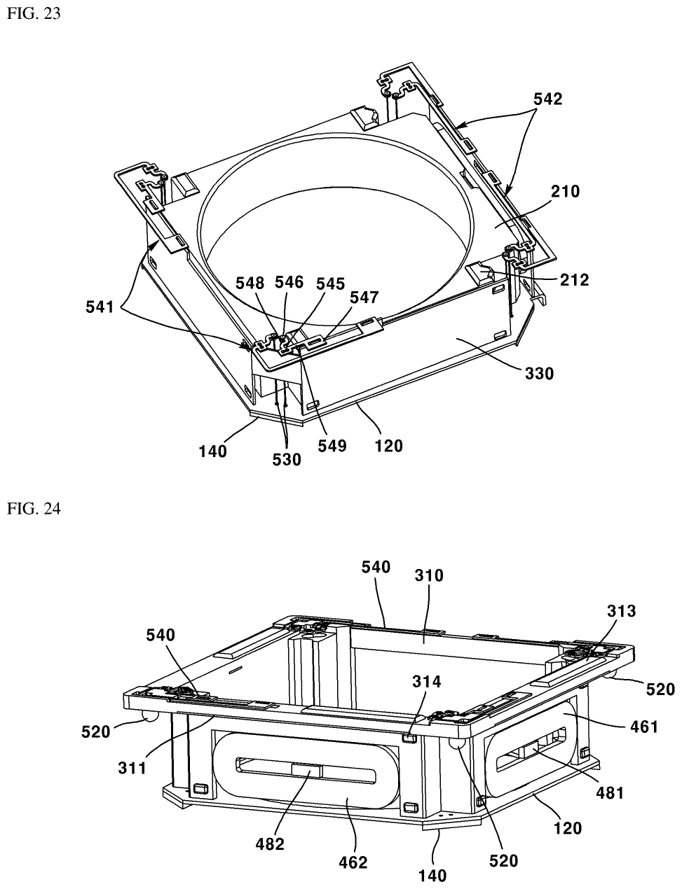

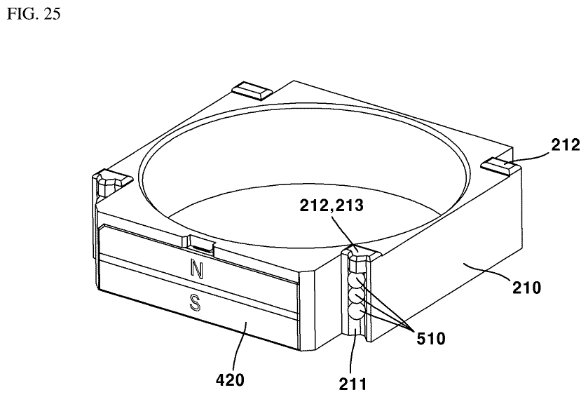

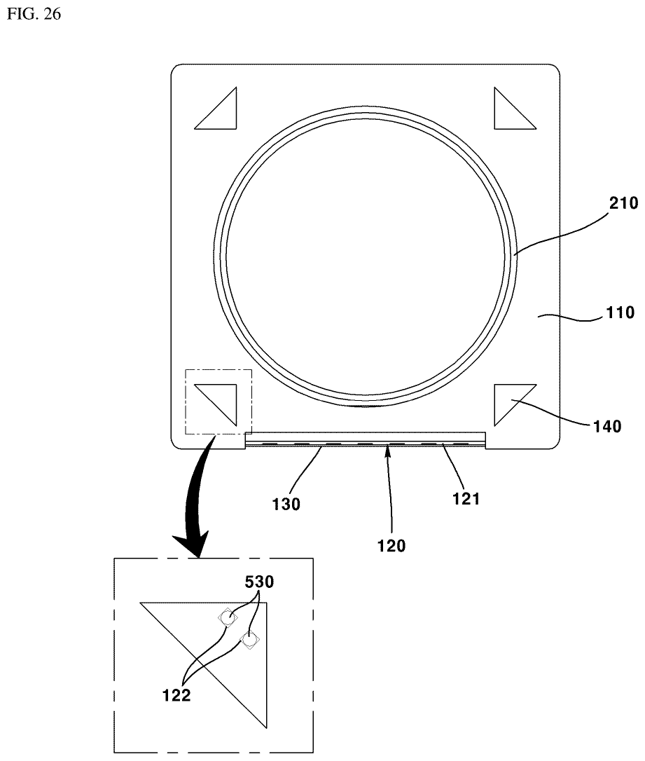

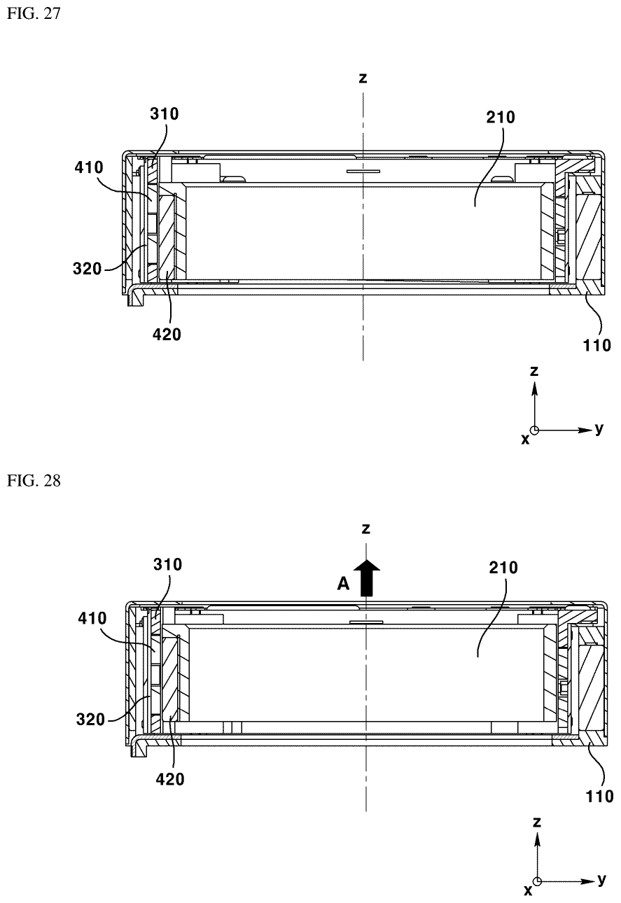

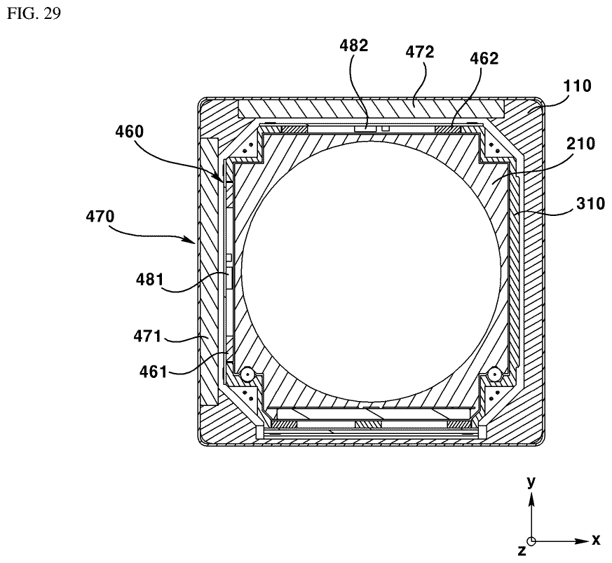

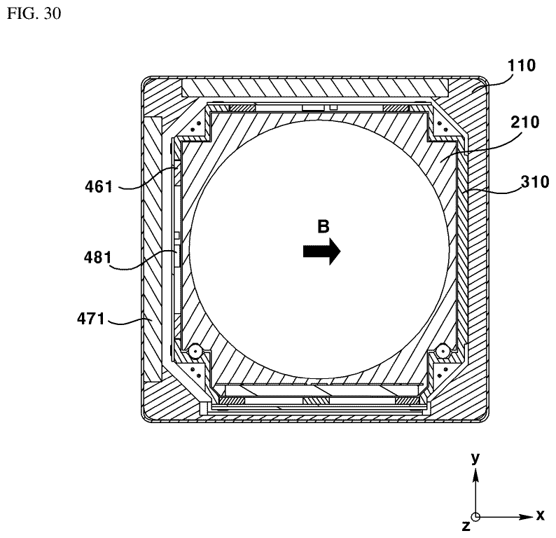

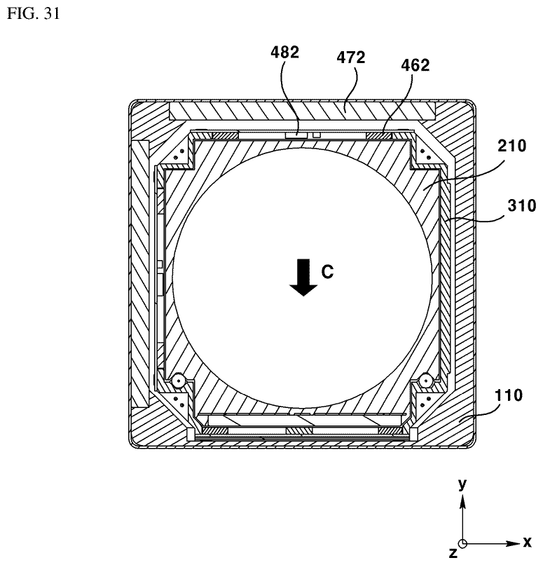

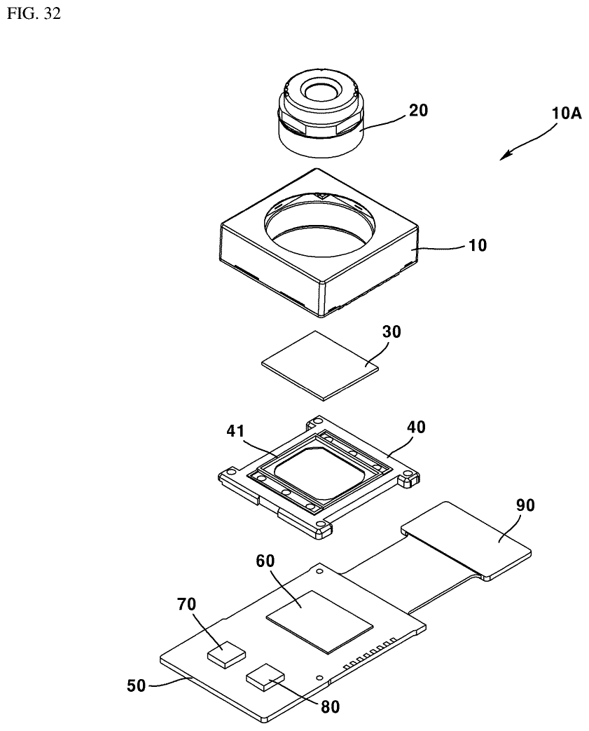

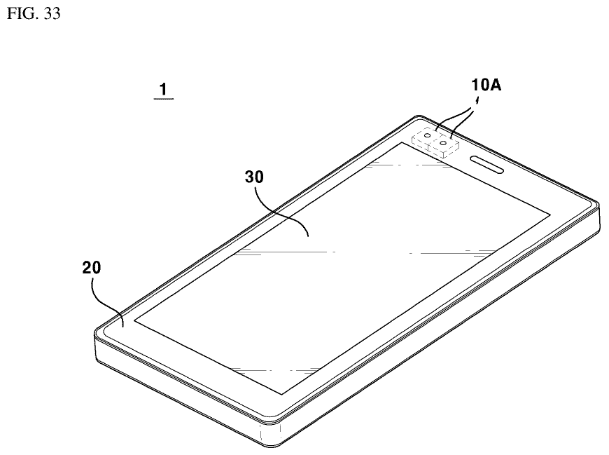

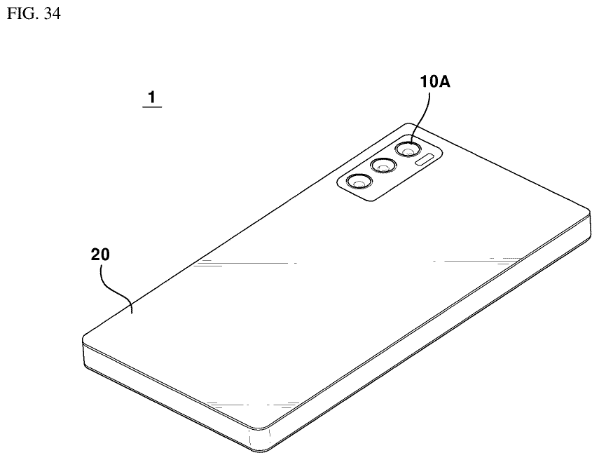

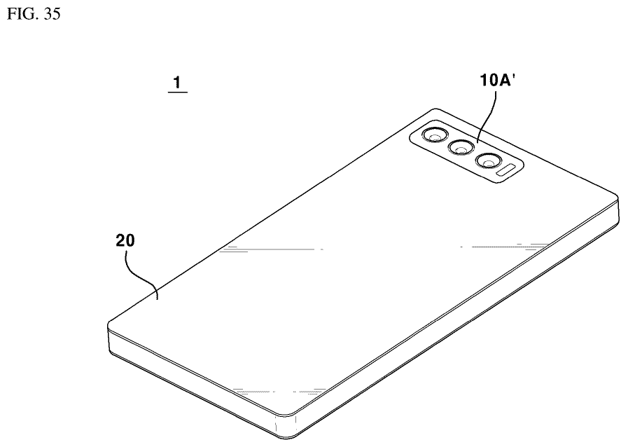

FIG. 1 is a perspective view of a lens driving device according to the present embodiment; FIG. 2 is a cross-sectional view taken along line A-A of FIG. 1; FIG. 3 is a cross-sectional view taken along line B-B of FIG. 1; FIG. 4 is a cross-sectional view taken along line C-C of FIG. 1; FIG. 5 is a cross-sectional view and a partially enlarged view illustrating a lens driving device according to the present embodiment cut in a direction perpendicular to the optical axis; FIG. 6 is an exploded perspective view of a lens driving device according to the present embodiment; FIG. 7 is an exploded perspective view of a lens driving device according to the present embodiment viewed from a different direction than FIG. 6; FIG. 8 is a perspective view of a lens driving device according to the present embodiment with a cover member omitted; FIG. 9 is a side see-through view illustrating a partial configuration of a lens driving device in the state of FIG. 8; FIG. 10 is a side see-through view illustrating an additional configuration by seeing through compared to FIG. 9; FIG. 11 is a cross-sectional view illustrating a cross-section in which an OIS guide ball is cut in a lens driving device according to the present embodiment; FIG. 12 is a perspective view of a lens driving device according to the present embodiment with a cover member and base omitted; FIG. 13 is a side see-through view illustrating a partial configuration of a lens driving device in the state of FIG. 12 by seeing through; FIG. 14 is a side see-through view illustrating an additional configuration compared to FIG. 13 by seeing through; FIG. 15 is a cross-sectional view illustrating a cross-section, in which an OIS guide ball is cut, in a lens driving device according to the present embodiment; FIG. 16 is a cross-sectional perspective view and partially enlarged view of a portion of a lens driving device according to the present embodiment; FIG. 17 is a cross-sectional perspective view illustrating a state in which the AF holder of a lens driving device according to the present embodiment moves upward and comes into contact with a upper plate of a cover member; FIG. 18 is a perspective view of a lens driving device according to the present embodiment with a cover member and an OIS holder omitted; FIG. 19 is a cross-sectional perspective view illustrating a cross-section cut in a way that some components are omitted in a lens driving device according to the present embodiment so that an OIS guide ball can be cut; FIG. 20 is a side view with some components omitted to show the arrangement of an AF guide ball and an OIS guide ball in a lens driving device according to the present embodiment; FIG. 21 is a perspective view of a lens driving device in the state of FIG. 20; FIGS. 22A and 22B are perspective views of some configurations of a lens driving device according to the present embodiment; FIG. 23 is a perspective view illustrating a coupled state of an elastic member, a wire, and a substrate of a lens driving device according to the present embodiment; FIG. 24 is a perspective view illustrating a partial configuration of a lens driving device according to the present embodiment; FIG. 25 is a perspective view illustrating an AF moving part and related configuration of a lens driving device according to the present embodiment; and FIG. 26 is a bottom view and partially enlarged view of a lens driving device according to the present embodiment.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed part 100. The fixed part 100 may be a stator. The fixed part 100 may be a relatively fixed part when the moving part moves.

The lens driving device 10 may comprise a base 110. The fixed part 100 may comprise a base 110. The base 110 may be disposed outside the AF holder 210. The base 110 may be disposed below the AF holder 210. The base 110 may be disposed outside the OIS holder 310. The base 110 may be disposed below the OIS holder 310. The base 110 may be coupled with cover member 130. The base 110 may form a lower surface of the lens driving device 10.

The base 110 may comprise a bottom plate unit 112. The FPCB 120 may be disposed in the bottom plate unit 112. An OIS holder 310 may be disposed on the bottom plate unit 112. The AF holder 210 may be disposed on the bottom plate unit 112.

The base 110 may comprise a side plate unit 113. The side plate unit 113 may be extended from the bottom plate unit 112. The side plate unit 113 may be extended upward from the bottom plate unit 112. The side plate unit 113 may be protruded upward from the bottom plate unit 112. The side plate unit 113 may be disposed to surround the side surface of the OIS holder 310. The side plate unit 113 may comprise a groove. An OIS guide ball 520 may be disposed in the groove of the side plate unit 113. The side plate unit 113 may comprise a hole. An OIS magnet 470 may be disposed in the hole of the side plate unit 113. The side plate unit 113 of the base 110 may comprise a pillar.

The base 110 may comprise a upper plate. The upper plate of the base 110 may be the upper end portion of the side plate unit 113.

The lens driving device 10 may comprise a metal plate 111. The fixed part 100 may comprise a metal plate 111. The metal plate 111 may be a metal member. The metal plate 111 may be a dent prevention member. The base 110 may comprise a metal plate 111. The metal plate 111 may be formed in the base 110 by insert injection. The metal plate 111 may be understood as a component of the base 110. Or, the metal plate 111 may be understood as a separate component from the base 110. The metal plate 111 may be disposed in the base 110. The metal plate 111 may be fixed to the base 110. The metal plate 111 may be coupled to the base 110. The metal plate 111 may be formed of a different material from the base 110. The metal plate 111 may be made of metal. The base 110 may be formed by injection molding.

The lens driving device 10 may comprise an FPCB 120. The fixed part 100 may comprise an FPCB 120. The FPCB 120 may be a substrate. The FPCB 120 may be a flexible printed circuit board. The FPCB 120 may be disposed in base 110. The FPCB 120 may be disposed in the bottom plate unit 111 of the base 110. The FPCB 120 may be coupled with the printed circuit board 50 of the camera device 10A. The FPCB 120 may be electrically connected to the printed circuit board 50 of the camera device 10A. The FPCB 120 may be connected to the printed circuit board 50 of the camera device 10A by a solder. The FPCB 120 may receive power from the printed circuit board 50 of the camera device 10A. The FPCB 120 may receive current from the printed circuit board 50 of the camera device 10A.

The FPCB 120 may comprise a terminal unit 121. The FPCB 120 may comprise a body unit. The body unit may be disposed in the bottom plate unit 112 of the base 110. The body unit may be disposed on an upper surface of the bottom plate unit 112 of the base 110. The terminal unit 121 may be extended from the body unit. The terminal unit 121 may be bent from the body unit. The terminal unit 121 is formed integrally with the body unit and can be bent. The terminal unit 121 may be extended downward from one edge of the body unit. The terminal unit 121 may be disposed on a side surface of the base 110. The terminal unit 121 may be disposed in a groove or recess being formed on a side surface of the base 110. The base 110 corresponds to the terminal unit 121 of the FPCB 120 so that the terminal unit 121 is disposed, or it may comprise a groove or recess being formed on a side surface of the base 110 with a width greater than that of the terminal unit 121.

The terminal unit 121 of the FPCB 120 may comprise a plurality of terminals. The terminal unit 121 may comprise 8 terminals. The four terminals of the terminal unit 121 may be electrically connected to the AF driver IC 430. The other four terminals of the terminal unit 121 may be electrically connected to the OIS-x driver IC 481 and the OIS-y driver IC 482. At this time, the slave address can be changed to integrate the OIS-x driver IC 481 and OIS-y driver IC 482 which respectively requires four terminals. Meanwhile, the terminal unit 121 may comprise 7 terminals. In this case, the ground terminal for the AF driver IC 430 and the ground terminal for the OIS driver IC 480 can be used together. In the present embodiment, both AF driving and feedback control and OIS driving and feedback control can be performed through the seven terminals.

The FPCB 120 may comprise terminals 122. The terminal 122 may be formed on a lower surface of the body unit of the FPCB 120. The lower end portion of the wire 540 may be coupled to the terminal 122 by a solder. An adhesive member 140 may be disposed in the terminal 122.

The lens driving device 10 may comprise a cover member 130. The fixed part 100 may comprise a cover member 130. The cover member 130 may be disposed in the base 110. The cover member 130 may be disposed on the base 110. The cover member 130 may be fixed to the base 110. The cover member 130 may be coupled to the base 110. The cover member 130 can accommodate the OIS holder 310 therein. The cover member 130 can accommodate the AF holder 210 therein. The cover member 130 may be a shield member. The cover member 130 may be a shield can. The cover member 130 can block electromagnetic interference (EMI). At this time, the cover member 130 may be an EMI shield can.

The cover member 130 may comprise a upper plate 131. The cover member 130 may comprise a side plate 132. The upper plate 131 may be disposed in a direction perpendicular to the optical axis. The side plate 132 may be disposed in a direction parallel to the optical axis. The side plate 132 may be extended from the upper plate 131. The side plate 132 may be extended downward from an edge of the upper plate 131. The side plate 132 may be formed integrally with the upper plate 131. The side plate 132 may be bent from the upper plate 131.

The side plate 132 may comprise a plurality of side plates. The side plate 132 may comprise four side plates. The side plate 132 may comprise first to fourth side plates. The side plate 132 may comprise: a first side plate and a second side plate being disposed on opposite sides of each other; and a third side plate and a fourth side plate being disposed on opposite sides of each other. The third side plate and the fourth side plate can connect the first side plate and the second side plate.

The lens driving device 10 may comprise an adhesive member 140. The fixed part 100 may comprise an adhesive member 140. The adhesive member 140 may be an adhesive. The adhesive member 140 may be a sealing member. The adhesive member 140 may have viscosity. The adhesive member 140 may comprise epoxy. The adhesive member 140 may be disposed at a lower end portion of the wire 530. The base 110 may comprise a hole to prevent interference with a conductive member connecting the wire 530 and the FPCB 120. The adhesive member 140 may be disposed in the hole of the base 110. The adhesive member 140 may seal the hole of the base 110. The hole of the base 110 may have a triangular shape. The base 110 may comprise a triangular-shaped hole. Solder connecting the lower end of the wire 530 and the FPCB 120 may be disposed in a triangular hole of the base 110. The triangular hole of the base 110 may be sealed by the adhesive member 140.

The lens driving device 10 may comprise a moving part. The moving part may be a mover. The moving part may be a movable part. The moving part may be a mover. The moving part can move with respect to the fixed part 100. The moving part may comprise the AF moving part 200. The moving part may comprise the OIS moving part 300.

The lens driving device 10 may comprise an AF moving part 200. The AF moving part 200 may be an AF mover. The AF moving part 200 may be an AF movable part. The AF moving part 200 may be an AF mover. The AF moving part 200 can move in a z-direction with respect to the OIS moving part 300. The z-direction may be the z-axis direction. The AF moving part 200 may move in an optical axis direction with respect to the fixed part 100 and/or the OIS moving part 300. The AF moving part 200, together with the OIS moving part 300, can move in a direction perpendicular to the optical axis with respect to the fixed part 100.

In the present embodiment, the AF moving part 200 may be disposed inside the OIS moving part 300. As a comparative example, the OIS moving part 300 may be disposed inside the AF moving part 200. In the present embodiment, compared to the comparative example, when driving AF, the OIS moving part 300 does not move and only the AF moving part 200 moves, so current consumption can be reduced compared to the comparative example in which the OIS moving part 300 and the AF moving part 200 are moved together.

The lens driving device 10 may comprise an AF holder 210. The AF moving part 200 may comprise an AF holder 210. The AF holder 210 may be disposed inside the OIS holder 310. The AF holder 210 may be disposed on the base 110. The AF holder 210 may be disposed inside the base 110. The AF holder 210 may be disposed inside the cover member 130. The AF holder 210 may be disposed to be movable in an optical axis direction. The AF holder 210 may be disposed to be movable in a direction perpendicular to the optical axis. The AF holder 210 can move in an optical axis direction with respect to the OIS holder 310. The AF holder 210, together with the OIS holder 310, can move in a direction perpendicular to the optical axis with respect to the base 110.

The AF holder 210 may comprise a groove 211. The groove 211 may be an AF guide ball accommodating groove. The groove 211 may be a guide rail. The groove 211 may be formed on a side surface of the AF holder 210. The groove 211 may be formed on an outer side surface of the AF holder 210. An AF guide ball 510 may be disposed in the groove 211. The groove 211 may be in contact with at least a portion of the AF guide ball 510. The groove 211 may be in contact with the AF guide ball 510 at three points. Or, the groove 211 may be in contact with the AF guide ball 510 at two points. The groove 211 may be extended in an optical axis direction. The groove 211 may be disposed in an optical axis direction. The groove 211 can be opened in one direction. The groove 211 may be open in one direction perpendicular to the optical axis. The groove 211 may be open in a downward direction. The groove 211 may be open in an x-axis direction and a downward direction.

The AF holder 210 may comprise an upper stopper 212. The upper stopper 212 may be formed on an upper surface of the AF holder 210. The upper stopper 212 may restrict movement of the AF holder 210 in an optical axis direction. The upper stopper 212 may be in contact with the upper plate 131 of the cover member 130. The upper stopper 212 may be in contact with the upper plate 131 of the cover member 130 when the AF holder 210 moves upward. The upper plate 131 of the cover member 130 may be overlapped with the AF holder 210 in an optical axis direction. The upper plate 131 of the cover member 130 may be overlapped with the upper stopper 212 of the AF holder 210 in an optical axis direction.

The AF holder 210 may comprise a cover portion 213. The cover portion 213 may be disposed above the AF guide ball 510. The cover portion 213 may be overlapped with the AF guide ball 510 in an optical axis direction. At least a portion of the cover portion 213 may be disposed in a first groove 312a and a second groove 312b of the OIS holder 310. Through this, the cover portion 213 can prevent the AF guide ball 510 from being separated. The cover portion 213 may be disposed to cover the AF guide ball 510. The cover portion 213 may be formed together with the upper stopper 212. That is, the cover portion 213 may be formed to also function as an upper stopper 212.

The AF holder 210 may comprise a groove 214. The groove 214 may be formed on an outer side surface of the AF holder 210. The groove 214 may be disposed on the AF magnet 420. Adhesive may be injected into the AF magnet 420 through the groove 214.

The lens driving device 10 may comprise an OIS moving part 300. The OIS moving part 300 may be an OIS operator. The OIS moving part 300 may be an OIS movable part. The OIS moving part 300 may be an OIS mover. The OIS moving part 300 can move in an x-direction or a y-direction with respect to the fixed part 100. The x-direction may be an x-axis direction and the y-direction may be a y-axis direction. The OIS moving part 300 can move in any one or more of an x-direction and a y-direction with respect to the fixed part 100. The OIS moving part 300 can move in a direction perpendicular to the optical axis with respect to the fixed part 100. At this time, the AF moving part 200 may move together with the OIS moving part 300.

The lens driving device 10 may comprise an OIS holder 310. The OIS moving part 300 may comprise an OIS holder 310. The OIS holder 310 may be disposed on the base 110. The OIS holder 310 may be disposed in the base 110. The OIS holder 310 may be disposed above the base 110. The OIS holder 310 may be disposed inside the base 110. The OIS holder 310 may be disposed inside the cover member 130. The OIS holder 310 may be disposed outside the AF holder 210. The OIS holder 310 may be disposed between the AF holder 210 and the base 110. The OIS holder 310 may be disposed between the AF holder 210 and the cover member 130. The OIS holder 310 may be disposed to be movable in a direction perpendicular to the optical axis. A magnet may not be disposed in the OIS holder 310. The driving magnet may be spaced apart from the OIS holder 310.

The OIS holder 310 may comprise grooves 312a and 312b. The grooves 312a and 312b may be AF guide ball receiving grooves. The grooves 312a and 312b may be guide rails. The grooves 312a and 312b may be formed on a side surface of the OIS holder 310. The grooves 312a and 312b of the OIS holder 310 may be disposed at positions corresponding to the grooves 211 of the AF holder 210. The grooves 312a and 312b may be formed on an inner side surface of the OIS holder 310. AF guide balls 510 may be disposed in the grooves 312a and 312b. The grooves 312a and 312b may be in contact with at least a portion of the AF guide ball 510. The grooves 312a and 312b may be in contact with the AF guide ball 510 at three points. Or, the grooves 312a and 312b may be in contact with the AF guide ball 510 at two points. The grooves 312a and 312b may be extended in an optical axis direction. The grooves 312a and 312b may be disposed in an optical axis direction. The grooves 312a and 312b can be open in one direction. The grooves 312a and 312b may be open in one direction perpendicular to the optical axis. The grooves 312a and 312b may be opened upward. The grooves 312a and 312b may be disposed more inward than the side surface of the OIS holder 310 to avoid interference with the wire 530.

The OIS holder 310 may comprise two surfaces that meet each other at an inner corner area. The grooves 312a and 312b may be formed on one of two surfaces. The inner shape of the OIS holder 310 may correspond to the outer shape of the AF holder 210.

The OIS holder 310 may comprise a first groove 312a. The first groove 312a may be a three-point contact groove. The first groove 312a may be in contact with the AF guide ball 510 at three points.

The OIS holder 310 may comprise a second groove 312b. The second groove 312b may be a two-point contact groove. The second groove 312b may be in contact with the AF guide ball 510 at two points. The second groove 312b may be formed in a different size from the first groove 312a. In a direction perpendicular to the optical axis, the width of the second groove 312b may be larger than the width of the first groove 312a.

The OIS holder 310 may comprise an upper stopper 313. The upper stopper 313 may be formed on an upper surface of the OIS holder 310. The upper stopper 313 may restrict movement of the OIS holder 310 in an optical axis direction. The upper stopper 313 may be in contact with the upper plate 131 of the cover member 130. The upper stopper 313 may be in contact with the upper plate 131 of the cover member 130 when the OIS holder 310 moves upward. The upper plate 131 of the cover member 130 may be overlapped with the upper stopper 313 of the OIS holder 310 in an optical axis direction.

The upper stopper 313 may comprise multiple upper stoppers. The upper stopper 313 may comprise three upper stoppers. The upper stopper 313 may be disposed on an upper surface of each of the three side plate units of the OIS holder 310. Or, as a modified embodiment, the upper stopper 313 may be formed in two or four pieces. Or, a plurality of side plate units may be formed in each side plate unit of the OIS holder 310.

The upper stopper 313 can maintain a state of being spaced apart from the upper plate 131 of the cover member 130 under normal driving conditions. However, when an impact occurs in a lens driving device, the upper stopper 313 may come into contact with the upper plate 131 of the cover member 130. The distance between the upper stopper 313 and the upper plate 131 of the cover member 130 may be 50 μm. The distance between the upper stopper 313 and the upper plate 131 of the cover member 130 may be 45 to 55 μm. The distance between the upper stopper 313 and the upper plate 131 of the cover member 130 may be 40 to 60 μm. The distance between the upper stopper 313 and the upper plate 131 of the cover member 130 may be less than 50% of the diameter of the OIS guide ball 520.

The upper stopper 313 may be protruded more upward than the elastic member 540. The upper stopper 313 may be protruded more upward than the upper end of the wire 530. Even if the OIS holder 310 moves upward, the upper stopper 313 may be in contact with the upper plate 131 of the cover member 130 to prevent the elastic member 540 and wire 530 from being in contact with the upper plate 131 of the cover member 130. Through this, a short circuit occurring when the elastic member 540 or the wire 530 comes into contact with the upper plate 131 of the cover member 130 can be prevented.

The OIS holder 310 may comprise a lateral stopper 314. The lateral stopper 314 may be formed on a side surface of the OIS holder 310. The lateral stopper 314 may be formed on the outer side surface of the OIS holder 310. The lateral stopper 314 may be formed to be protruded outward from a side surface of the OIS holder 310. The lateral stopper 314 may penetrate the AF substrate 320 or the OIS substrate 330. The AF substrate 320 and/or the OIS substrate 330 may comprise a hole into which the lateral stopper 314 is inserted. The lateral stopper 314 may restrict movement of the OIS holder 310 in a lateral direction. The lateral stopper 314 may be in contact with the fixed part 100 or the OIS magnet 470 when the OIS holder 310 moves in a direction perpendicular to the optical axis. The lateral stopper 314 may comprise a first lateral stopper in contact with the base 110 and a second lateral stopper in contact with the OIS magnet 470. At this time, the first lateral stopper may be protruded more than the second lateral stopper. Through this, after the first lateral stopper hits the base 110, the second lateral stopper is in contact with the OIS magnet 470, thereby minimizing the impact being applied to the OIS magnet 470.

The OIS holder 310 may comprise a upper plate unit 315. The upper plate unit 315 may be disposed on the side plate unit 113 of the base 110. The upper plate unit 315 may be disposed above the side plate unit 113 of the base 110. An OIS guide ball 520 may be disposed in the upper plate unit 315.

The OIS holder 310 may comprise a side plate unit 316. The side plate unit 316 may be extended downward from the upper plate unit 315. The AF substrate 320 may be disposed in the side plate unit 316. An OIS substrate 330 may be disposed in the side plate unit 316. A hole or groove in which the AF coil 410 is disposed may be formed in the side plate unit 316. A hole or groove in which the OIS coil 460 is disposed may be formed in the side plate unit 316.

The OIS holder 310 may comprise a protruded portion 317. The protruded portion 317 may be formed in the side plate unit 316 of the OIS holder 310. The protruded portion 317 may be protruded outward. Through this, the protruded portion 317 can function as a lateral stopper. The protruded portion 317 may be provided to compensate for the weight of the OIS substrate 330 and the OIS coil 460 being disposed on opposite sides. Accordingly, the protruded portion 317 may have a weight corresponding to the weight of the OIS substrate 330 and the OIS coil 460 being disposed on opposite sides.

The OIS holder 310 may comprise a step portion 318. The step portion 318 may be formed on an upper surface of the OIS holder 310. The step portion 318 may comprise a groove being formed concavely on an upper surface of the OIS holder 310. The step portion 318 may comprise a shape to avoid interference with the elastic member 540. An elastic member 540 may be disposed in the step portion 318. The upper surface of the elastic member 540 disposed in the step portion 318 may be disposed lower than the upper surface of the upper stopper 313.

The OIS holder 310 may comprise a pillar part 319. The pillar part 319 may be formed in an inner corner area of the OIS holder 310. The pillar part 319 may be protruded inward from an inner corner area of the OIS holder 310. The pillar part 319 may comprise four pillar parts. Grooves 312a and 312b in which the AF guide ball 510 is disposed may be formed in two of the four pillar parts. The pillar part 319 may be formed as two surfaces parallel to an optical axis are met.

The lens driving device 10 may comprise a metal plate 311. The metal plate 311 may be a metal member. The metal plate 311 may be a dent prevention member. The OIS moving part 300 may comprise a metal plate 311. The OIS holder 310 may comprise a metal plate 311. The metal plate 311 may be formed in the OIS holder 310 by insert injection. The metal plate 311 may be understood as a component of the OIS holder 310. Or, the metal plate 311 may be understood as a separate component of the OIS holder 310. The metal plate 311 may be disposed in the OIS holder 310. The metal plate 311 may be fixed to the OIS holder 310. The metal plate 311 may be coupled to the OIS holder 310. The metal plate 311 may be formed of a different material from the OIS holder 310. The metal plate 311 may be formed of metal. The OIS holder 310 may be formed by injection molding. The metal plate 311 may have magnetism. An attractive force may act between the metal plate 311 and the OIS magnet 470.

The lens driving device 10 may comprise an AF substrate 320. The OIS moving part 300 may comprise an AF substrate 320. The AF substrate 320 may be disposed in the OIS holder 310. The AF substrate 320 may be fixed to the OIS holder 310. The AF substrate 320 may be coupled to the OIS holder 310. The AF substrate 320 may be disposed on an outer surface of the OIS holder 310. The AF substrate 320 may be coupled to an outer side of the OIS holder 310. The AF substrate 320 may be disposed on a side surface of the OIS holder 310. The AF substrate 320 may be disposed inside the base 110. The AF substrate 320 may be disposed inside the cover member 130. The AF substrate 320 may be formed separately from the OIS substrate 330. The AF substrate 320 may be spaced apart from the OIS substrate 330. The AF substrate 320 may be separated from the OIS substrate 330. As a modified embodiment, the AF substrate 320 may be coupled to the inside of the OIS holder 310.

The AF substrate 320 may be electrically connected to the FPCB 120 through a plurality of second elastic members 542 and a plurality of second wires 532. The AF substrate 320 may be electrically connected to a plurality of second elastic members 542. The AF substrate 320 may be electrically connected to a plurality of second wires 532. The AF substrate 320 may be electrically connected to the FPCB 120.

The OIS holder 310 may comprise a hole. The AF substrate 320 may be disposed in a hole of the OIS holder 310. The AF substrate 320 may be disposed parallel to the optical axis.

The AF substrate 320 may comprise a terminal 321. The terminal 321 may be disposed at an upper end of the AF substrate 320. The terminal 321 may be formed at an upper end of the AF substrate 320. The terminal 321 may be disposed at an upper portion of the AF substrate 320. The terminal 321 may be coupled to the elastic member 540. The terminal 321 may be coupled to the elastic member 540 by a solder. The terminal 321 may be coupled to the elastic member 540 by a conductive epoxy. The terminal 321 may be coupled to the elastic member 540 by welding. The terminal 321 of the AF substrate 320 may be coupled to the second elastic member 542.

The terminal 321 may pass through the elastic member 540. The elastic member 540 may comprise a hole through which at least a portion of the terminal 321 penetrates. The terminal 321 of the AF substrate 320 may be inserted into the hole of the elastic member 540. The terminal 321 may be formed on a side surface of the AF substrate 320. The terminal 321 may be formed on an outer side surface of the AF substrate 320. Or, the terminal 321 may be formed on an inner side surface of the AF substrate 320.

The lens driving device 10 may comprise an OIS substrate 330. The OIS moving part 300 may comprise an OIS substrate 330. The OIS substrate 330 may be disposed in the OIS holder 310. The OIS substrate 330 may be fixed to the OIS holder 310. The OIS substrate 330 may be coupled to the OIS holder 310. The OIS substrate 330 may be disposed on an outer surface of the OIS holder 310. The OIS substrate 330 may be coupled to an outer side of the OIS holder 310. The OIS substrate 330 may be disposed on two adjacent side surfaces of the OIS holder 310. The OIS substrate 330 may be disposed inside the base 110. The OIS substrate 330 may be disposed inside the cover member 130. From the inside to the outside, the OIS coil 460, the OIS substrate 330, and the OIS magnet 470 may be disposed in that order.

As a modified embodiment, the OIS substrate 330 may be coupled to the inside of the OIS holder 310. In this case, the OIS substrate 330, the OIS coil 460, and the OIS magnet 470 may be disposed in that order from the inside to the outside. At this time, the OIS coil 460 and the OIS magnet 470 may face each other directly.

At least a portion of the OIS substrate 330 may be disposed between the OIS coil 460 and the OIS magnet 470. At least a portion of the OIS substrate 330 may be disposed to be overlapped with the OIS coil 460 and the OIS magnet 470. The OIS substrate 330 may comprise a first portion being disposed between the OIS-x coil 461 and the OIS-x magnet 471. The OIS substrate 330 may comprise a second portion being disposed between the OIS-y coil 462 and the OIS-y magnet 472.

The OIS substrate 330 may be electrically connected to the FPCB 120 through a plurality of first elastic members 541 and a plurality of first wires 531. The OIS substrate 330 may be electrically connected to a plurality of first elastic members 541. The OIS substrate 330 may be electrically connected to a plurality of first wires 531. The OIS substrate 330 may be electrically connected to the FPCB 120.

The OIS substrate 330 may comprise a first portion being disposed on a first side surface of the OIS holder 310 and a second portion being disposed on a second side surface adjacent to a first side surface of the OIS holder 310. The OIS substrate 330 may be formed integrally. The OIS substrate 330 may comprise a third portion connecting the first portion and the second portion.

The OIS holder 310 may comprise a hole. The OIS substrate 330 may be disposed in the hole of the OIS holder 310. The OIS substrate 330 may be disposed parallel to an optical axis.

The OIS substrate 330 may comprise a terminal 331. The terminal 331 may be disposed at an upper end of the OIS substrate 330. The terminal 331 may be formed at an upper end of the OIS substrate 330. The terminal 331 may be disposed at an upper portion of the OIS substrate 330. The terminal 331 may be coupled to the elastic member 540. The terminal 331 may be coupled to the elastic member 540 by a solder. The terminal 331 may be coupled to the elastic member 540 by a conductive epoxy. The terminal 331 may be coupled to the elastic member 540 by welding. The terminal 331 of the OIS substrate 330 may be coupled to the first elastic member 541.

The terminal 331 may pass through the elastic member 540. The elastic member 540 may comprise a hole through which at least a portion of the terminal 331 penetrates. The terminal 331 of the OIS substrate 330 may be inserted into the hole of the elastic member 540. The terminal 331 may be formed on a side surface of the OIS substrate 330. The terminal 331 may be formed on an outer side surface of the OIS substrate 330. Or, the terminal 331 may be formed on an inner side surface of the OIS substrate 330.

The lens driving device 10 may comprise a yoke 340. The OIS moving part 300 may comprise a yoke 340. The yoke 340 may be disposed in the AF substrate 320. An AF coil 410 may be disposed on a first surface of the AF substrate 320. The yoke 340 may be disposed on a second surface of the AF substrate 320, which is opposite to the first surface. The yoke 340 may be formed to have a size corresponding to the AF substrate 320. The yoke 340 may be formed in a shape corresponding to the AF substrate 320. The yoke 340 may be disposed at a position corresponding to the AF magnet 420. An attractive force may be generated between the yoke 340 and the AF magnet 420. Since the AF holder 210 is pressed toward the yoke 340 by the attractive force between the yoke 340 and the AF magnet 420, so the AF guide ball 510 can be maintained without being separated between the grooves 211 of the AF holder 210 and the grooves 312a and 312b of the OIS holder 310.

The lens driving device 10 may comprise a driving unit. The driving unit can move the lens. The driving unit can move the lens through electromagnetic force. The driving unit may comprise a coil and a magnet.

The lens driving device 10 may comprise an AF driving unit. The driving unit may comprise an AF driving unit. The AF driving unit can move the lens. The AF driving unit can move the lens in an optical axis direction. The AF driving unit can move the AF holder 210 in an optical axis direction. The AF driving unit can move the lens in an optical axis direction through electromagnetic force. The AF driving unit may comprise a coil and a magnet.

The lens driving device 10 may comprise an AF coil 410. The AF driving unit may comprise an AF coil 410. The AF coil 410 can move the AF holder 210 in an optical axis direction. The AF coil 410 may interact with the AF magnet 420. The AF coil 410 may interact electromagnetically with the AF magnet 420. When current is applied to the AF coil 410, the AF coil 410 can move the AF magnet 420 through electromagnetic interaction with the AF magnet 420. Or, when current is applied to the AF coil 410, the AF coil 410 may move with respect to the AF magnet 420 through electromagnetic interaction with the AF magnet 420. The AF coil 410 and the AF magnet 420 may face each other. The AF coil 410 may face the AF magnet 420. The AF coil 410 may be disposed at a position corresponding to the AF magnet 420. The AF coil 410 may be overlapped with the AF magnet 420 in a first direction perpendicular to the optical axis.

The AF coil 410 may be disposed in the AF substrate 320. The AF coil 410 may be coupled to the AF substrate 320. The AF coil 410 may be driving unit in the OIS holder 310. The AF coil 410 may be fixed to the OIS holder 310. The AF coil 410 may be coupled to the OIS holder 310. The AF coil 410 may be disposed in the OIS moving part 300. The AF coil 410 may be spaced apart from the AF holder 210. The AF coil 410 may be spaced apart from the base 110. The AF coil 410 may be spaced apart from the cover member 130.

The lens driving device 10 may comprise an AF magnet 420. The AF driving unit may comprise an AF magnet 420. The AF magnet 420 can move the AF holder 210 in an optical axis direction. The AF magnet 420 may be disposed in the AF holder 210. The AF magnet 420 may be fixed to the AF holder 210. The AF magnet 420 may be coupled to the AF holder 210. The AF magnet 420 can move together with the AF holder 210. When current is applied to the AF coil 410, the AF magnet 420 may move together with the AF holder 210. The AF magnet 420 may be driving unit on the AF moving part 200.

The AF magnet 420 may comprise a 4-pole magnet. The AF magnet 420 may comprise an N pole and an S pole in an upper portion and an N pole and an S pole in a lower portion. A neutral portion with no or weak polarity may be disposed between the upper and lower portions of the AF magnet 420.

The lens driving device 10 may comprise an insert 421. The insert 421 may be a yoke. The insert 421 may be disposed between the AF magnet 420 and the AF holder 210. A groove 214 for disposing the insert 421 therein may be formed in the AF holder 210. A portion of the insert 421 may be disposed in the groove 214. The insert 421 may be bent at 90 degrees and inserted into the groove 214 of the AF holder 210. The insert 421 can increase the adhesion force of the AF magnet 420.

The lens driving device 10 may comprise an AF driver IC 430. The AF driving unit may comprise an AF driver IC 430. The AF driver IC 430 may be electrically connected to the AF coil 410. The AF driver IC 430 may apply current to the AF coil 410. The AF driver IC 430 can control the current being applied to the AF coil 410. The AF driver IC 430 may be disposed in the AF substrate 320. The AF driver IC 430 may be disposed inside the AF coil 410. The AF driver IC 430 may be disposed in a hollow of the AF coil 410.

The AF driver IC 430 may comprise a Hall element. The AF driver IC 430 may comprise a Hall IC. The AF driver IC 430 may comprise a Hall sensor. The AF driver IC 430 may comprise a sensor. The AF driver IC 430 can detect the magnetic force of the AF magnet 420. Through this, the AF driver IC 430 can detect the movement of the AF magnet 420 and the AF holder 210.

The lens driving device 10 may comprise an OIS driving unit. The driving unit may comprise an OIS driving unit. The OIS driving unit can move the lens. The OIS driving unit can move the lens in a direction perpendicular to the optical axis. The OIS driving unit can move the AF holder 210 and the OIS holder 310 in a direction perpendicular to the optical axis. The OIS driving unit can move the lens in a direction perpendicular to the optical axis through electromagnetic force. The OIS driving unit may comprise a coil and a magnet.

The lens driving device 10 may comprise an OIS coil 460. The OIS driving unit may comprise an OIS coil 460. The OIS coil 460 can move the OIS holder 310 in a direction perpendicular to the optical axis. The OIS coil 460 can move the AF holder 210 in a direction perpendicular to the optical axis. The OIS coil 460 can move the AF holder 210 and the OIS holder 310 together in a direction perpendicular to the optical axis. The OIS coil 460 may interact with OIS magnet 470. The OIS coil 460 may electromagnetically interact with the OIS magnet 470. When current is applied to the OIS coil 460, the OIS coil 460 can move with respect to the OIS magnet 470 through electromagnetic interaction with the OIS magnet 470. Or, when current is applied to the OIS coil 460, the OIS coil 460 may move the OIS magnet 470 through electromagnetic interaction with the OIS magnet 470. The OIS coil 460 and the OIS magnet 470 may face each other. The OIS coil 460 may face the OIS magnet 470. The OIS coil 460 may be disposed in a position corresponding to the OIS magnet 470.

The OIS coil 460 may comprise a first coil being overlapped with the OIS magnet 470 in a first direction perpendicular to the optical axis, and a second coil being overlapped therewith in a second direction perpendicular to both the optical axis and the first direction. Any one of the first coil and the second coil is an OIS-x coil 461 and the other one may be an OIS-y coil 462.

The OIS coil 460 may be disposed in the OIS substrate 330. The OIS coil 460 may be fixed to the OIS substrate 330. The OIS coil 460 may be coupled to the OIS substrate 330. The OIS coil 460 may be disposed in the OIS holder 310. The OIS coil 460 may be fixed to the OIS holder 310. The OIS coil 460 may be coupled to the OIS holder 310. The OIS coil 460 may be disposed in the OIS moving part 300. The OIS coil 460 may be spaced apart from the AF holder 210. The OIS coil 460 may be spaced apart from the base 110. The OIS coil 460 may be spaced apart from the cover member 130.

The lens driving device 10 may comprise an OIS-x coil 461. The OIS driving unit may comprise an OIS-x coil 461. The OIS coil 460 may comprise an OIS-x coil 461. The OIS-x coil 461 may be disposed in a first direction perpendicular to the optical axis. The OIS-x coil 461 can move the OIS holder 310 in an x-direction perpendicular to the optical axis. The OIS-x coil 461 and the OIS-x magnet 471 may face each other. The OIS-x coil 461 may face the OIS-x magnet 471. The OIS-x coil 461 may be disposed in a position corresponding to the OIS-x magnet 471. The OIS-x coil 461 may be overlapped with the OIS-x magnet 471 in a second direction perpendicular to both the optical axis and the first direction. The OIS-x coil 461 can move the OIS holder 310 in a second direction through interaction with the OIS-x magnet 471.

The lens driving device 10 may comprise an OIS-y coil 462. The OIS driving unit may comprise an OIS-y coil 462. The OIS coil 460 may comprise an OIS-y coil 462. The OIS-y coil 462 may be disposed in a second direction perpendicular to both the optical axis and the first direction. The OIS-y coil 462 may be disposed in a direction perpendicular to the OIS-x coil 461. The OIS-y coil 462 can move the OIS holder 310 in a y-direction perpendicular to the optical axis. The OIS-y coil 462 and the OIS-y magnet 472 may face each other. The OIS-y coil 462 may face the OIS-y magnet 472. The OIS-y coil 462 may be disposed in a position corresponding to the OIS-y magnet 472. The OIS-y coil 462 may be overlapped with the OIS-y magnet 472 in a first direction perpendicular to the optical axis. The OIS-y coil 462 can move the OIS holder 310 in a first direction through interaction with the OIS-y magnet 472.

The lens driving device 10 may comprise an OIS magnet 470. The OIS driving unit may comprise an OIS magnet 470. The OIS magnet 470 can move the OIS holder 310 in a direction perpendicular to the optical axis. The OIS magnet 470 may be disposed in the base 110. The OIS magnet 470 may be fixed to the base 110. The OIS magnet 470 may be coupled to the base 110. The OIS magnet 470 can move the OIS holder 310 together with the OIS coil 460. When current is applied to the OIS coil 460, the OIS magnet 470 can move the OIS holder 310 together with the OIS coil 460. The OIS magnet 470 may be disposed in the fixed part 100.

The OIS magnet 470 may comprise a two-pole magnet. The OIS magnet 470 may comprise two magnets. The OIS magnet 470 may comprise a plurality of magnets. The OIS magnet 470 may comprise two magnets being disposed in directions perpendicular to each other. Each of the two magnets may be a two-pole magnet.

The lens driving device 10 may comprise an OIS-x magnet 471. The OIS driving unit may comprise an OIS-x magnet 471. The OIS magnet 470 may comprise an OIS-x magnet 471. The OIS-x magnet 471 may interact with OIS-x coil 461. The OIS-x magnet 471 may electromagnetically interact with the OIS-x coil 461. The OIS-x magnet 471 may be disposed on a first side surface of the base 110. The OIS-x magnet 471 can be disposed in one direction. The OIS-x magnet 471 may be disposed parallel to an optical axis in the base 110.

The lens driving device 10 may comprise an OIS-y magnet 472. The OIS driving unit may comprise an OIS-y magnet 472. The OIS magnet 470 may comprise an OIS-y magnet 472. The OIS-y magnet 472 may interact with OIS-y coil 462. The OIS-y magnet 472 may electromagnetically interact with the OIS-y coil 462. The OIS-y magnet 472 may be disposed on a second side surface adjacent to the first side surface of the base 110. The OIS-y magnet 472 may be disposed in a direction perpendicular to one direction. The OIS-y magnet 472 may be disposed parallel to an optical axis in the base 110.

The lens driving device 10 may comprise an OIS driver IC 480. The OIS driving unit may comprise an OIS driver IC 480. The OIS driver IC 480 may be electrically connected to the OIS coil 460. The OIS driver IC 480 may apply current to the OIS coil 460. The OIS driver IC 480 can control the current applied to the OIS coil 460. The OIS driver IC 480 may be disposed in the OIS substrate 330. The OIS driver IC 480 may be disposed inside the OIS coil 460. The OIS driver IC 480 may be disposed in a hollow of the OIS coil 460.

The OIS driver IC 480 may comprise a Hall element. The OIS driver IC 480 may comprise a Hall IC. The OIS driver IC 480 may comprise a Hall sensor. OIS driver IC 480 may comprise a sensor. The OIS driver IC 480 can detect the magnetic force of the OIS magnet 470. Through this, the OIS driver IC 480 can detect the movement of the OIS magnet 470 and the OIS holder 310.

The lens driving device 10 may comprise an OIS-x driver IC 481. The OIS driving unit may comprise an OIS-x driver IC 481. The OIS driver IC 480 may comprise an OIS-x driver IC 481. The OIS-x driver IC 481 may be electrically connected to the OIS-x coil 461. The OIS-x driver IC 481 can apply current to the OIS-x coil 461. The OIS-x driver IC 481 can control the current being applied to the OIS-x coil 461. The OIS-x driver IC 481 may be disposed inside the OIS-x coil 461. The OIS-x driver IC 481 may be disposed in a hollow of the OIS-x coil 461.

The OIS-x driver IC 481 may comprise a Hall element. The OIS-x driver IC 481 may comprise a Hall IC. The OIS-x driver IC 481 may comprise a Hall sensor. The OIS-x driver IC 481 may comprise a sensor. The OIS-x driver IC 481 can detect the magnetic force of the OIS-x magnet 471. Through this, the OIS-x driver IC 481 can detect the movement of the OIS-x magnet 471 and the OIS holder 310.

The lens driving device 10 may comprise an OIS-y driver IC 482. The OIS driving unit may comprise an OIS-y driver IC 482. The OIS driver IC 480 may comprise an OIS-y driver IC 482. The OIS-y driver IC 482 may be electrically connected to the OIS-y coil 462. The OIS-y driver IC 482 may apply current to the OIS-y coil 462. The OIS-y driver IC 482 can control the current being applied to the OIS-y coil 462. The OIS-y driver IC 482 may be disposed inside the OIS-y coil 462. The OIS-y driver IC 482 may be disposed in a hollow of the OIS-y coil 462.

The OIS-y driver IC 482 may comprise a Hall element. The OIS-y driver IC 482 may comprise a Hall IC. The OIS-y driver IC 482 may comprise a Hall sensor. The OIS-y driver IC 482 may comprise a sensor. The OIS-y driver IC 482 can detect the magnetic force of the OIS-y magnet 472. Through this, the OIS-y driver IC 482 can detect the movement of the OIS-y magnet 472 and the OIS holder 310.

The lens driving device 10 may comprise a guide unit. The guide unit may guide the movement of the lens. The guide unit may comprise a first guide unit that guides the movement of the lens in an optical axis direction. The guide unit may comprise a second guide unit that guides the movement of the lens in a direction perpendicular to the optical axis.

The lens driving device 10 may comprise an AF guide ball 510. The guide unit may comprise an AF guide ball 510. The AF guide ball 510 may be disposed between the OIS holder 310 and the AF holder 210. The AF guide ball 510 may be disposed in the OIS holder 310 and the AF holder 210. The AF guide ball 510 can connect the OIS holder 310 and the AF holder 210. The AF guide ball 510 may be in contact with the OIS holder 310 and the AF holder 210. However, when grease is applied to the surface of the AF guide ball 510, the AF guide ball 510 does not directly contact the OIS holder 310 and the AF holder 210, but the grease may be in contact with the OIS holder 310 and the AF holder 210. The AF guide ball 510 may be disposed between the inner side surface of the OIS holder 310 and the outer side surface of the AF holder 210.

The AF guide ball 510 may have a spherical shape. The AF guide ball 510 may be a ball. The AF guide ball 510 can roll along the surface of the AF holder 210. The AF guide ball 510 can move along the surface of the AF holder 210. The AF guide ball 510 can roll along the surface of the OIS holder 310. The AF guide ball 510 can move along the surface of the OIS holder 310.

The AF guide ball 510 may guide the movement of the AF holder 210 in an optical axis direction. The AF guide ball 510 may limit the movement of the AF holder 210 with respect to the OIS holder 310 in an optical axis direction. The AF guide ball 510 may guide the movement of the AF holder 210 in an optical axis direction.

The AF guide ball 510 may comprise a plurality of AF guide balls. A plurality of AF guide balls may be disposed to be overlapped with each other in an optical axis direction. A plurality of AF guide balls may be overlapped with each other in a vertical direction. All of the plurality of AF guide balls may be disposed on a virtual plane parallel to an optical axis.

The AF guide ball 510 may comprise six balls. The AF guide ball 510 may comprise a first ball having a first diameter and a second ball having a second diameter smaller than the first diameter. The AF guide ball 510 may comprise three balls being disposed on one side of the AF magnet 420 and three balls being disposed on the other side of the AF magnet 420. The three balls may comprise two first balls and one second ball. The second ball may be disposed between the two first balls.

The lens driving device 10 may comprise an OIS guide ball 520. The guide unit may comprise an OIS guide ball 520. The OIS guide ball 520 may be disposed between the base 110 and the OIS holder 310. The OIS guide ball 520 may be disposed in the base 110 and the OIS holder 310. The OIS guide ball 520 can connect the base 110 and the OIS holder 310. The OIS guide ball 520 may contact the base 110 and the OIS holder 310. However, when grease is applied to the surface of the OIS guide ball 520, the OIS guide ball 520 does not directly contact the base 110 and the OIS holder 310, but the grease may be in contact with the base 110 and the OIS holder 310.

The OIS guide ball 520 may be disposed more outward than the area of the OIS moving part 300 being connected to the wire 530. When viewed from above, the OIS guide ball 520 may be disposed more outward than the area of the OIS moving part 300 being connected to the wire 530. The OIS guide ball 520 may be disposed more outward than the wire 530. The OIS guide ball 520 may be disposed more outward than the AF guide ball 510.

The OIS guide ball 520 may be disposed between the metal plate 111 of the base 110 and the metal plate 311 of the OIS holder 310. The OIS guide ball 520 may be disposed in the metal plate 111 of the base 110 and the metal plate 311 of the OIS holder 310. The OIS guide ball 520 can connect the metal plate 111 of the base 110 and the metal plate 311 of the OIS holder 310. The OIS guide ball 520 may be in contact with the metal plate 111 of the base 110 and the metal plate 311 of the OIS holder 310. However, when grease is applied to the surface of the OIS guide ball 520, the OIS guide ball 520 does not directly contact the two metal plates 111 and 311, but the grease may be in contact with the two metal plates 111 and 311. For example, the metal plate 111 being disposed in the base 110 may be non-magnetic and the metal plate 311 being disposed in the OIS holder 310 may be magnetic.

The OIS guide ball 520 may have a spherical shape. The OIS guide ball 520 may be a ball. The OIS guide ball 520 can roll along the surface of the OIS holder 310. The OIS guide ball 520 can move along the surface of the OIS holder 310. The OIS guide ball 520 may roll along the surface of the base 110. The OIS guide ball 520 can move along the surface of the base 110.

The OIS guide ball 520 may guide the movement of the OIS holder 310 in a direction perpendicular to the optical axis. The OIS guide ball 520 may limit the movement of the OIS holder 310 with respect to the base 110 in a direction perpendicular to the optical axis. The OIS guide ball 520 may guide the movement of the OIS holder 310 in a direction perpendicular to the optical axis.

The OIS guide ball 520 may be disposed higher than the ball being disposed highest among the plurality of AF guide balls 510. The OIS guide ball 520 may be disposed higher than the AF coil 410. The OIS guide ball 520 may be disposed higher than the AF magnet 420. The OIS guide ball 520 may be disposed higher than the OIS coil 460. The OIS guide ball 520 may be disposed higher than the OIS magnet 470. The OIS guide ball 520 may be disposed on a lower surface of the upper plate unit 315 of the OIS holder 310. The OIS guide ball 520 may be disposed in a groove being formed on an upper surface of the side plate unit 113 of the base 110.

The OIS guide ball 520 may be disposed between the upper plate of the base 110 and the upper plate unit 315 of the OIS holder 310. The OIS guide ball 520 may guide the OIS holder 310 to move in an x-direction and a y-direction perpendicular to the optical axis with respect to the base 110. Here, the x-direction may be an x-axis direction and the y-direction may be a y-axis direction.

The upper plate of the base 110 may comprise a groove in which the OIS guide ball 520 is disposed. The groove of the base 110 may have a size larger than the maximum diameter of the OIS guide ball 520. When arranging to match the center of the OIS guide ball 520 with the center of the groove of the base 110, the OIS guide ball 520 can be spaced apart from an inner side surface of the groove of the base 110 in x-direction and y-direction.

The OIS guide ball 520 may comprise a plurality of OIS guide balls. A plurality of OIS guide balls may be disposed to be overlapped with one another in a direction perpendicular to the optical axis. A plurality of OIS guide balls may be overlapped with one another in a horizontal direction. All of the plurality of OIS guide balls may be disposed on a virtual plane perpendicular to the optical axis. A plurality of OIS guide balls may be formed to have the same size and shape.

The OIS guide ball 520 may have first to fourth unit balls. The OIS guide ball 520 may have only the first to fourth unit balls. The first unit ball can guide the OIS holder 310 to move in an x-direction and a y-direction perpendicular to the optical axis with respect to the base 110. Each of the first to fourth unit balls can guide the OIS holder 310 to move in an x-direction and a y-direction perpendicular to the optical axis with respect to the base 110. The first unit ball may guide the OIS holder 310 to move with respect to the base 110 in a first direction perpendicular to the optical axis and in a second direction perpendicular to both the optical axis and the first direction. As a modified embodiment, the OIS guide ball 520 may comprise first to fourth unit balls. That is, in the modified embodiment, the OIS guide ball 520 may comprise additional unit balls in addition to the first to fourth unit balls. The OIS guide ball 520 may comprise four balls.

The four balls may be overlapped with one another in a direction perpendicular to the optical axis. Four balls may be disposed in each of the four corner areas of the base 110. Four balls can be disposed in each of the four corner areas of the upper plate unit 315 of the OIS holder 310.

When the OIS holder 310 moves, the OIS guide ball 520 may guide the base 110 to move in a direction perpendicular to the optical axis. The OIS guide ball 520 may guide the movement of the OIS holder 310 in an x-axis direction. The OIS guide ball 520 may guide the movement of the OIS holder 310 in a y-axis direction. The OIS guide ball 520 can guide the movement of the OIS holder 310 in both the x-axis and y-axis directions. That is, the OIS guide ball 520 can be formed as an all-in-one type with one ball without distinguishing between the x-axis ball and the y-axis ball. Since the OIS guide ball 520 is provided as an all-in-one type, crosstalk, which affects the x-axis driving force and y-axis driving force, may be a problem, in the present embodiment, cross talk can be minimized through the wire 530. The OIS guide ball 520 may be disposed between the OIS holder 310 and the base 110 in an optical axis direction.

Pressure on the OIS guide ball 520 may be applied by the wire 530 and the elastic member 540. That is, the OIS holder 310 is pressed in the direction towards the base 110 by the elastic force and rigidity of the wire 530 and the elastic member 540, thereby preventing the OIS guide ball 520 from being separated. Or, the OIS holder 310 may be provided with a yoke being disposed at a position corresponding to the OIS magnet 470. In this case, the phenomenon of the OIS guide ball 520 being separated due to the attractive force between the yoke and the OIS magnet 470 can be prevented.

The OIS guide ball 520 may be disposed in the metal plates 111 and 311. The flatness of the rolling surface of the OIS guide ball 520 can be easily managed by the metal plates 111 and 311. In addition, the metal plates 111 and 311 can prevent dents from occurring in the OIS guide ball 520 and/or the OIS holder 310 and the base 110 due to impact. The metal plates 111 and 311 may be yokes.

The OIS guide ball 520 may be protruded beyond the upper surface of the base 110. The OIS guide ball 520 may be protruded above the upper surface of the base 110. The upper surface of the base 110 and the upper plate unit 315 of the OIS holder 310 may be spaced apart as much as the protruded height of the OIS guide ball 520. The OIS guide ball 520 may be disposed in a groove being recessed from the upper surface of the base 110. At this time, the distance between the upper surface of the base 110 and the upper plate unit 315 of the OIS holder 310 may be 80 to 450 μm. Or, the distance between the upper surface of the base 110 and the upper plate unit 315 of the OIS holder 310 may be 80 to 600 μm. The distance between the upper surface of the base 110 and the upper plate unit 315 of the OIS holder 310 may be, for example, 150 μm. The distance between the upper surface of the base 110 and the upper plate unit 315 of the OIS holder 310 may be greater than the distance between the OIS holder 310 and the upper plate 131 of the cover member 130.

The lens driving device 10 may comprise a wire 530. The guide portion may comprise a wire 530. The wire 530 may be an elastic member. The wire 530 may have elasticity. The wire 530 may be formed of metal. The wire 530 may connect the FPCB 120 and the elastic member 540. The upper end portion of the wire 530 may be coupled to the elastic member 540. The upper end portion of the wire 530 may be coupled to the elastic member 540 with a solder. The lower end portion of the wire 530 may be coupled to the FPCB 120. The lower end portion of the wire 530 may be coupled to the FPCB 120 by a solder. The wire 530 may be disposed parallel to the optical axis. The wire 530 can elastically support the movement of the OIS moving part 300.

The wire 530 may comprise a plurality of wires. The wire 530 may comprise eight wires. Two of the wires 530 may be disposed in each of the four corner areas of the OIS holder 310. Or, the wire 530 may comprise four wires. Two wires 530 may be coupled to at least one corner of the OIS holder 310.

The wire 530 may comprise a first wire 531. The wire 530 may comprise a plurality of first wires 531 being spaced apart from one another. The first wire 531 may comprise a plurality of first wires 531. The first wire 531 may comprise a plurality of first wires 531 being spaced apart from each other. The first wire 531 may be electrically connected to the OIS substrate 330.

The wire 530 may comprise a second wire 532. The wire 530 may comprise a plurality of second wires 532 being spaced apart from one another. The second wire 532 may comprise a plurality of second wires 532. The second wire 532 may comprise a plurality of second wires 532 being spaced apart from one another. The second wire 532 may be electrically connected to the AF substrate 320.

The lens driving device 10 may comprise an elastic member 540. The guide portion may comprise an elastic member 540. The elastic member 540 may comprise a leaf spring. The elastic member 540 may have elasticity. The elastic member 540 may be formed of metal. The elastic member 540 may be coupled to the OIS holder 310. The elastic member 540 may comprise a portion being coupled to the OIS holder 310. The elastic member 540 may comprise a portion being disposed in the OIS holder 310. The elastic member 540 may comprise a portion fixed to the OIS holder 310. The elastic member 540 may be coupled to the wire 530. The elastic member 540 may be coupled to the AF substrate 320. The elastic member 540 may be coupled to the OIS substrate 330.

The elastic member 540 may comprise a first elastic member 541. The elastic member 540 may comprise a plurality of first elastic members 541 being spaced apart from one another. The first elastic member 541 may comprise a plurality of first elastic members 541. The first elastic member 541 may comprise a plurality of first elastic members 541 being spaced apart from one another. The first elastic member 541 may be a ‘first elastic unit’. The first elastic member 541 may be electrically connected to the OIS substrate 330.

The elastic member 540 may comprise a second elastic member 542. The elastic member 540 may comprise a plurality of second elastic members 542 being spaced apart from one another. The second elastic member 542 may comprise a plurality of second elastic members 542. The second elastic member 542 may comprise a plurality of second elastic members 542 being spaced apart from one another. The second elastic member 542 may be a ‘second elastic unit’. The second elastic member 542 may be electrically connected to the AF substrate 320.

The elastic member 540 may comprise a first coupling part 545. The first coupling part 545 may be an OIS holder coupling part. The first coupling part 545 may be coupled to the OIS holder 310. The first coupling part 545 may be disposed with the OIS holder 310. The first coupling part 545 may be fixed to the OIS holder 310. The first coupling part 545 may comprise a hole being coupled to a protrusion of the OIS holder 310. The first coupling part 545 may be coupled to the OIS holder 310 through an adhesive.

The elastic member 540 may comprise a second coupling part 546. The second coupling part 546 may be a wire coupling part. The second coupling part 546 may be coupled to the wire 530. The second coupling part 546 may comprise a hole through which the wire 530 passes. The second coupling part 546 may be coupled to the wire 530 by a solder. The solder may be disposed on an upper surface of the second coupling part 546.

The elastic member 540 may comprise a third coupling part 547. The third coupling part 547 may be a substrate terminal coupling part. The third coupling part 547 may be coupled to the substrate. The third coupling part 547 may comprise a first portion being coupled to the AF substrate 320. The third coupling part 547 may comprise a first portion being coupled to the terminal 321 of the AF substrate 320. The third coupling part 547 may comprise a second portion being coupled to the OIS substrate 330. The third coupling part 547 may comprise a second portion being coupled to the terminal 331 of the OIS substrate 330.

The elastic member 540 may comprise a first connection part 548. The first connection part 548 may be an inner connection part. The first connection part 548 may connect the first coupling part 545 and the second coupling part 546. The first connection part 548 can elastically connect the first coupling part 545 and the second coupling part 546.

The elastic member 540 may comprise a second connection part 549. The second connection part 549 may be an inner connection part. The second connection part 549 may connect the first coupling part 545 and the third coupling part 547. The second connection part 549 can elastically connect the first coupling part 545 and the third coupling part 547.

Hereinafter, the operation of the lens driving device according to the present embodiment will be described with reference to the drawings.

First, the autofocus function will be described with reference to FIGS. 27 and 28.

FIGS. 27 and 28 are diagrams for explaining autofocus driving of the lens driving device according to the present embodiment.

The AF moving part 200 may be disposed in the body unit of the FPCB 120 at an initial position where no current is applied to the AF coil 410. Or, the AF moving part 200 may be disposed on an upper surface of the bottom plate unit 112 of the base 110 in an initial position where no current is applied to the AF coil 410. When current is applied to the AF coil 410, the AF magnet 420 can move upward along an optical axis due to electromagnetic interaction between the AF coil 410 and the AF magnet 420 (see A in FIG. 28). At this time, the AF holder 210 and the lens may move together with the AF magnet 420. Accordingly, the distance between the lens and the image sensor can be changed to adjust the focus of the image being formed on the image sensor through the lens.

Meanwhile, during the movement of the AF magnet 420, the AF driver IC 430 can detect the amount of movement or position of the AF magnet 420 by detecting the strength of the magnetic field of the AF magnet 420. The movement amount or position of the AF magnet 420 detected by the AF driver IC 430 can be used for autofocus feedback control.

As another example, the AF moving part 200 may be disposed in a position spaced apart from the base 110 and the FPCB 120 in an initial position where no current is applied to the AF coil 410. At this time, when a reverse current is applied to the AF coil 410, the AF moving part 200 may move downward toward the lower plate of the base 110. Conversely, when a forward current is applied to the AF coil 410, the AF moving part 200 may move upward toward the upper plate 131 of the cover member 130. Even in this case, the lens moves together with the AF moving part 200 so that the distance between the lens and the image sensor can be adjusted.

Next, the optical image stabilization function will be described with reference to FIGS. 29 to 31.

FIGS. 29 to 31 are diagrams for explaining optical image stabilization operation of a lens driving device according to the present embodiment.

The OIS moving part 300 may be disposed to be spaced apart from the fixed part 100 at an initial position where no current is applied to the OIS coil 460. At this time, when a forward current is applied to the OIS-x coil 461, due to the electromagnetic interaction between the OIS-x coil 461 and the OIS-x magnet 471, the OIS-x coil 461 can move in a direction away from the OIS-x magnet 471 in an x-axis direction (see B in FIG. 30). Conversely, when a reverse current is applied to the OIS-x coil 461, the OIS-x coil 461 can move in a direction closer to the OIS-x magnet 471 in an x-axis direction by electromagnetic interaction between the OIS-x coil 461 and the OIS-x magnet 471. Meanwhile, when a forward current is applied to the OIS-y coil 462, the OIS-y coil 462 can move in a direction away from the OIS-y magnet 472 in a y-axis direction by the electromagnetic interaction between the OIS-y coil 462 and the OIS-y magnet 472 (see C in FIG. 31). Conversely, when a reverse current is applied to the OIS-y coil 462, the OIS-y coil 462 may move in a direction closer to the OIS-y magnet 472 in a y-axis direction by electromagnetic interaction between the OIS-y coil 462 and the OIS-y magnet 472.

In the previous description, the lens can move integrally with the OIS coil 460 along with the AF mover 200 and the OIS mover 300.

During the movement of the OIS coil 460, the OIS driver IC 480 can detect the amount of movement or position of the OIS magnet 470 by detecting the strength of the magnetic field of the OIS magnet 470. The movement amount or position of the OIS magnet 470 detected by the OIS driver IC 480 can be used for optical image stabilization feedback control.

Hereinafter, a camera device according to the present embodiment will be described with reference to the drawings.

FIG. 32 is an exploded perspective view of a camera device according to the present embodiment.

The camera device 10A may comprise a camera module.

The camera device 10A may comprise a lens module 20. The lens module 20 may comprise at least one lens. The lens may be disposed in a position corresponding to the image sensor 60. The lens module 20 may comprise a lens and a barrel. The lens module 20 may be coupled to the AF holder 210 of the lens driving device 10. The lens module 20 may be coupled to the AF holder 210 by screw-coupling and/or an adhesive. The lens module 20 can be moved integrally with the AF holder 210. The lens may be coupled to the AF holder 210.

The camera device 10A may comprise a filter 30. The filter 30 may serve to block light in a specific frequency band from light passing through the lens module 20 from entering the image sensor 60. The filter 30 may be disposed parallel to an x-y plane. The filter 30 may be disposed between the lens module 20 and the image sensor 60. The filter 30 may be disposed in sensor base 40. As a modified embodiment, the filter 30 may be disposed in the base 110. The filter 30 may comprise an infrared filter. The infrared filter may block light in the infrared region from being incident on the image sensor 60.

The camera device 10A may comprise a sensor base 40. The sensor base 40 may be disposed between the lens driving device 10 and the printed circuit board 50. The sensor base 40 may comprise a protruded portion 41 on which the filter 30 is disposed. An opening may be formed in a portion of the sensor base 40 where the filter 30 is disposed to allow light passing through the filter 30 to enter the image sensor 60. An adhesive member may couple or attach the base 310 of the lens driving device 10 to the sensor base 40. The adhesive member may additionally serve to prevent foreign substances from entering the interior of the lens driving device 10. The adhesive member may comprise one or more among epoxy, thermosetting adhesive, and ultraviolet curing adhesive.

The camera device 10A may comprise a printed circuit board (PCB) 50. The printed circuit board 50 may be a substrate or a circuit board. A lens driving device 10 may be disposed in the printed circuit board 50. A sensor base 40 may be disposed between the printed circuit board 50 and the lens driving device 10. The printed circuit board 50 may be electrically connected to the lens driving device 10. An image sensor 60 may be disposed in the printed circuit board 50. The printed circuit board 50 may be equipped with various circuits, elements, and control units to convert the image being formed in the image sensor 60 into an electrical signal and transmit it to an external device.

The camera device 10A may comprise an image sensor 60. The image sensor 60 may be a configuration in which an image is formed as a light passing through the lens and the filter 30 is incident thereon. The image sensor 60 may be mounted on the printed circuit board 50. The image sensor 60 may be electrically connected to the printed circuit board 50. For example, the image sensor 60 may be coupled to the printed circuit board 50 using surface mounting technology (SMT). As another example, the image sensor 60 may be coupled to the printed circuit board 50 using a flip chip technology. The image sensor 60 may be disposed so that its optical axis coincides with that of the lens. That is, the optical axis of the image sensor 60 and the optical axis of the lens may be aligned. The image sensor 60 can convert light being irradiated to the effective image area of the image sensor 60 into an electrical signal. The image sensor 60 may be one among a charge coupled device (CCD), a metal oxide semiconductor (MOS), a CPD, and a CID.

The camera device 10A may comprise a motion sensor 70. The motion sensor 70 may be mounted on the printed circuit board 50. The motion sensor 70 may be electrically connected to the control unit 80 through a circuit pattern provided on the printed circuit board 50. The motion sensor 70 may output rotational angular velocity information resulting from the movement of the camera device 10A. The motion sensor 70 may comprise a 2-axis or 3-axis gyro sensor, or an angular velocity sensor.

The camera device 10A may comprise a control unit 80. The control unit 80 may be disposed in the printed circuit board 50. The control unit 80 may be electrically connected to the coil 330 of the lens driving device 10. The control unit 80 can individually control the direction, intensity, and amplitude of the current being supplied to the coil 330. The control unit 80 may control the lens driving device 10 to perform an autofocus function and/or an optical image stabilization function. Furthermore, the control unit 80 may perform autofocus feedback control and/or optical image stabilization feedback control for the lens driving device 10.

The camera device 10A may comprise a connector 90. The connector 90 may be electrically connected to the printed circuit board 50. The connector 90 may comprise a port for electrical connection to an external device.

Hereinafter, an optical instrument according to the present embodiment will be described with reference to the drawings.

FIG. 33 is a perspective view of an optical instrument according to the present embodiment; FIG. 34 is a perspective view of an optical device according to the present embodiment seen from a direction different from that of FIG. 33; and FIG. 35 is a perspective view of an optical device according to a modified embodiment.

An optical instrument 1 may comprise any one or more among a hand phone, a portable phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation. The optical instrument 1 may comprise any device for photographing images or photos.

The optical instrument 1 may comprise a main body 20. The optical instrument 1 may comprise a camera device 10A. The camera device 1010 may be disposed in the main body 20. The camera device 10A may photograph a subject. The optical instrument 1 may comprise a display 1030. The display 30 may be disposed in the main body 20. The display 30 may output any one or more of a video and an image photographed by the camera device 10A. The display 30 may be disposed on the first surface of the main body 20. The camera device 10A may be disposed on any one or more of a first surface of the main body 20 and a second surface opposite to the first surface.

The camera device 10A may be disposed on a front surface of the main body 20 where the display 30 is disposed. The camera device 10A may be disposed on a rear surface opposite to the front surface of the main body 20. The camera device 10A may comprise a plurality of camera devices being disposed on a rear surface of the main body 20 to be spaced apart in a long side direction of the main body 20.

As a modified embodiment, the camera device 10A′ may comprise a plurality of camera devices being disposed on a rear surface of the main body 20 to be spaced apart in a short side direction of the main body 20.

Although the embodiment of the present invention has been described above with reference to the accompanying drawings, those of ordinary skill in the art to which the present invention belongs will understand that the present invention may be embodied in other specific forms without changing the technical spirit or essential features thereof. Therefore, it should be understood that the embodiments described above are illustrative in all respects and not restrictive.

1. A lens driving device comprising:
a base;
a first holder disposed on the base;
a second holder disposed in the first holder;
a first coil and a first magnet configured to move the second holder in an optical axis direction;
a second coil and a second magnet configured to move the first holder in an x-direction or a y-direction perpendicular to an optical axis; and
a first ball disposed between an upper plate of the base and an upper plate of the first holder,
wherein the first ball is configured to guide the first holder to move in the x-direction and the y-direction perpendicular to the optical axis with respect to the base.

2. The lens driving device of claim 1, wherein the upper plate of the base comprises a first groove disposed with the first ball, and
wherein the first groove has a size greater than a maximum diameter of the first ball.

3. The lens driving device of claim 2, wherein when a center of the first ball and a center of the first groove are disposed to coincide with each other, a side surface of the first ball is spaced apart from an inner side surface of the first groove in the x-direction and the y-direction.

4. The lens driving device of claim 1, wherein the first ball has first to fourth unit balls, and
wherein the first unit ball is configured to guide the first holder to move in the x-direction and the y-direction perpendicular to the optical axis with respect to the base.

5. The lens driving device of claim 1, comprising:
a second ball disposed between the first holder and the second holder,
wherein the second ball is configured to guide the second holder to move in the optical axis direction with respect to the first holder.

6. The lens driving device of claim 5, wherein an inner side surface of the first holder comprises a second groove configured to guide the second ball, and
wherein an outer side surface of the second holder comprises a third groove disposed at a position corresponding to the second groove of the first holder.

7. The lens driving device of claim 6, wherein an inner corner area of the first holder comprises two surfaces meeting each other, and
wherein the second groove is formed on one of the two surfaces.

8. The lens driving device of claim 1, wherein an inner shape of the first holder corresponds to an outer shape of the second holder.

9. The lens driving device of claim 1, comprising a wire configured to support the first holder with respect to the base.

10. (canceled)

11. The lens driving device of claim 1, comprising:
a first substrate disposed on the base;
an elastic member disposed on the first holder; and
a wire connecting the first substrate and the elastic member.

12. The lens driving device of claim 1, comprising a second substrate disposed on the first holder,
wherein the second coil is disposed on the second substrate.

13. The lens driving device of claim 12, wherein the second magnet is disposed on the base.

14. The lens driving device of claim 13, wherein the second substrate is disposed between the second coil and the second magnet to be overlapped with the second coil and the second magnet.

15. The lens driving device of claim 1, comprising a third substrate disposed on the first holder,
wherein the first coil is disposed on the third substrate.

16. The lens driving device of claim 15, wherein the first magnet is disposed on the second holder.

17. A camera device comprising:
a printed circuit board;
an image sensor disposed on the printed circuit board;
the lens driving device of claim 1 disposed on the printed circuit board; and
a lens coupled with the lens driving device.

18. An optical instrument comprising:
a main body;
the camera device of claim 17 disposed on the main body; and
a display disposed on the main body and configured to output an image photographed by the camera device.

19. A lens driving device comprising:
a base;
a first holder disposed on the base;
a second holder disposed in the first holder;
a first magnet disposed on the second holder;
a second magnet disposed on the base;
a first coil and a second coil coupled with the first holder;
a first ball disposed between the base and the first holder; and
a second ball disposed between the first holder and the second holder,
wherein the first ball is disposed between an upper plate of the base and an upper plate of the first holder, and
wherein the second ball is disposed between an inner side surface of the first holder and an outer side surface of the second holder.

20. A lens driving device comprising:
a fixed part;
a first moving part configured to move in an x-direction or a y-direction with respect to the fixed part;
a second moving part configured to move in a z-direction with respect to the first moving part;
a first ball disposed between the fixed part and the first moving part;
a second ball disposed between the first moving part and the second moving part; and
a wire coupled with the fixed part and the first moving part,
wherein the first ball is configured to guide the first moving part to move in the x-direction and the y-direction and is disposed outside an area of the first moving part connected with the wire.

21. The lens driving device of claim 20, wherein two of the wires are coupled to at least one corner of the first moving part.
